(19) United States
(12) Patent Application Publication
(10) Pub. No.: US 2026/0254553 A1
(43) Pub. Date: Aug. 27, 2026

(54) POWER SCALING FACTOR SELECTION TECHNIQUES FOR PROBABILISTICALLY SHAPED SYSTEMS

(71) Applicant: QUALCOMM INCORPORATED, San Diego, CA (US)

(72) Inventors: Wei Yang, San Diego, CA (US); Liangming Wu, Beijing (CN); Jing Jiang, San Diego, CA (US); Gabi Sarkis, San Diego, CA (US)

(21) Appl. No.: 18/861,847

(22) PCT Filed: Jun. 30, 2022
(86) PCT No.: PCT/CN2022/102653

§ 371 Date: Oct. 30, 2024

(51) Int. Cl. H04L 1/00

(52) U.S. Cl. CPC H04L 1/0003; H04L 1/0009

(57) ABSTRACT

This disclosure provides systems, methods and apparatus, including computer programs encoded on computer storage media, for power scaling factor selection techniques for probabilistically shaped systems. In some aspects, communicating devices may support probabilistic amplitude shaping such that constellation points with relatively larger or smaller amplitudes are selected relatively more or less than often than they would be without shaping and may apply one or more power scaling procedures that are specifically associated with probabilistic amplitude shaping to achieve a target or expected average transmit power across a set of transmitted modulation symbols. The communicating devices may support a first power scaling procedure associated with a first power scaling factor for an initial transmission and may support a second power scaling procedure for a retransmission.

### CROSS REFERENCE

This present Application is a 371 national stage filing of International PCT Application No. PCT/CN2022/102653 by Yang et al. entitled “POWER SCALING FACTOR SELECTION TECHNIQUES FOR PROBABILISTICALLY SHAPED SYSTEMS,” filed Jun. 30, 2022, which is assigned to the assignee hereof, and which is expressly incorporated by reference in its entirety herein.

### TECHNICAL FIELD

This disclosure relates to wireless communications, including power scaling factor selection techniques for probabilistically shaped systems.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a wireless device. The method may include selecting, according to a coded modulation scheme associated with a data message and a probabilistic shaping scheme associated with information bits of the data message, a power scaling factor corresponding to the data message and transmitting the data message according to the coded modulation scheme, including encoding the information bits according to the probabilistic shaping scheme and applying a power scaling to the data message according to the power scaling factor.

Another innovative aspect of the subject matter described in this disclosure can be implemented in an apparatus for wireless communications at a passive wireless device. The apparatus may include an interface and a processing system. The processing system may be configured to select, according to a coded modulation scheme associated with a data message and a probabilistic shaping scheme associated with information bits of the data message, a power scaling factor corresponding to the data message. The interface may be configured to output the data message according to the coded modulation scheme, including encoding the information bits according to the probabilistic shaping scheme and applying a power scaling to the data message according to the power scaling factor.

Another innovative aspect of the subject matter described in this disclosure can be implemented in an apparatus for wireless communications at a wireless device. The apparatus may include a processor, memory coupled with the processor, and instructions stored in the memory. The instructions may be executable by the processor to cause the apparatus to select, according to a coded modulation scheme associated with a data message and a probabilistic shaping scheme associated with information bits of the data message, a power scaling factor corresponding to the data message and transmit the data message according to the coded modulation scheme, including encoding the information bits according to the probabilistic shaping scheme and applying a power scaling to the data message according to the power scaling factor.

Another innovative aspect of the subject matter described in this disclosure can be implemented in another apparatus for wireless communications at a wireless device. The apparatus may include means for selecting, according to a coded modulation scheme associated with a data message and a probabilistic shaping scheme associated with information bits of the data message, a power scaling factor corresponding to the data message and means for transmitting the data message according to the coded modulation scheme, including encoding the information bits according to the probabilistic shaping scheme and applying a power scaling to the data message according to the power scaling factor.

Another innovative aspect of the subject matter described in this disclosure can be implemented in a non-transitory computer-readable medium storing code for wireless communications at a wireless device. The code may include instructions executable by a processor to select, according to a coded modulation scheme associated with a data message and a probabilistic shaping scheme associated with information bits of the data message, a power scaling factor corresponding to the data message and transmit the data message according to the coded modulation scheme, including encoding the information bits according to the probabilistic shaping scheme and applying a power scaling to the data message according to the power scaling factor.

One innovative aspect of the subject matter described in this disclosure can be implemented in a method for wireless communications at a wireless device. The method may include selecting, according to a coded modulation scheme associated with a data message and a probabilistic shaping scheme associated with information bits of the data message, a power scaling factor corresponding to the data message and receiving the data message according to the coded modulation scheme, including decoding the information bits according to the probabilistic shaping scheme and accounting for a power scaling of the data message according to the power scaling factor.

Another innovative aspect of the subject matter described in this disclosure can be implemented in an apparatus for wireless communications at a passive wireless device. The apparatus may include an interface and a processing system. The processing system may be configured to select, according to a coded modulation scheme associated with a data message and a probabilistic shaping scheme associated with information bits of the data message, a power scaling factor corresponding to the data message. The interface may be configured to obtain the data message according to the coded modulation scheme, including decoding the information bits according to the probabilistic shaping scheme and accounting for a power scaling of the data message according to the power scaling factor.

Another innovative aspect of the subject matter described in this disclosure can be implemented in an apparatus for wireless communications at a wireless device. The apparatus may include a processor, memory coupled with the processor, and instructions stored in the memory. The instructions may be executable by the processor to cause the apparatus to select, according to a coded modulation scheme associated with a data message and a probabilistic shaping scheme associated with information bits of the data message, a power scaling factor corresponding to the data message and receive the data message according to the coded modulation scheme, including decoding the information bits according to the probabilistic shaping scheme and accounting for a power scaling of the data message according to the power scaling factor.

Another innovative aspect of the subject matter described in this disclosure can be implemented in another apparatus for wireless communications at a wireless device. The apparatus may include means for selecting, according to a coded modulation scheme associated with a data message and a probabilistic shaping scheme associated with information bits of the data message, a power scaling factor corresponding to the data message and means for receiving the data message according to the coded modulation scheme, including decoding the information bits according to the probabilistic shaping scheme and accounting for a power scaling of the data message according to the power scaling factor.

Another innovative aspect of the subject matter described in this disclosure can be implemented in a non-transitory computer-readable medium storing code for wireless communications at a wireless device. The code may include instructions executable by a processor to select, according to a coded modulation scheme associated with a data message and a probabilistic shaping scheme associated with information bits of the data message, a power scaling factor corresponding to the data message and receive the data message according to the coded modulation scheme, including decoding the information bits according to the probabilistic shaping scheme and accounting for a power scaling of the data message according to the power scaling factor.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of a wireless communications system that supports power scaling factor selection techniques for probabilistically shaped systems.

FIG. 2 shows an example signaling diagram that supports power scaling factor selection techniques for probabilistically shaped systems.

FIG. 3 shows an example circular buffer that supports power scaling factor selection techniques for probabilistically shaped systems.

FIG. 4 shows example transmission schemes that support power scaling factor selection techniques for probabilistically shaped systems.

FIG. 5 shows an example process flow that supports power scaling factor selection techniques for probabilistically shaped systems.

FIG. 6 shows a block diagram of an example device that supports power scaling factor selection techniques for probabilistically shaped systems.

FIGS. 7 and 8 show flowcharts illustrating methods that support power scaling factor selection techniques for probabilistically shaped systems.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing third generation (3G), fourth generation (4G) or fifth generation (5G), or further implementations thereof, technology.

In some systems, a transmitting device may modulate a set of information bits onto a carrier frequency using a constellation point associated with the set of information bits. The constellation point may be selected from a defined constellation, or set, of points in a plane (such as a plane defined by in-phase (I) and quadrature (Q) components of the carrier frequency) where each point in the constellation corresponds to a different set or permutation of information bits. In some modulation schemes, the selection probability for each constellation point may be approximately equal. Such modulation schemes may be associated with shaping loss at relatively higher signal-to-noise ratio (SNR) values, which may refer to how an achievable information rate plateaus at various SNR values depending on the specific modulation scheme. Further, in some systems (such as in cellular or wireless fidelity (Wi-Fi) systems), to increase spectral efficiency at increasingly higher signal-to-noise ratio (SNR) values, devices may use increasingly higher modulation orders.

To address such shaping loss and maintain sufficient spectral efficiency, some systems may deploy a modulation scheme associated with probabilistic shaping, which may be a technique to generate non-uniformly distributed constellation points. In some examples of probabilistic shaping, such as probabilistic amplitude shaping, constellation points associated with larger amplitudes may be selected more or less frequently than constellation points associated with lower amplitudes (where amplitude correlates positively with transmit power). As part of a transmit operation, a transmitting device may apply a power scaling factor to increase the likelihood that signals transmitted via selected constellation points have an average power equal to a constant value (such as a value of 1). Some systems may employ a fixed power scaling factor for each modulation and coding scheme (MCS). Such a fixed power scaling factor may be incompatible with transmissions associated with probabilistic shaping (such as probabilistic amplitude shaping), as a transmitting device may use transmit powers for such transmissions that are weighted toward relatively higher or lower transmit powers.

In some implementations, a transmitting device and a receiving device may support one or more signaling- or configuration-based mechanisms according to which the transmitting device and the receiving device may apply a power scaling procedure to a transmission associated with probabilistic shaping. In such implementations, the transmitting device and the receiving device may select, identify, ascertain, or otherwise determine a power scaling factor associated with the power scaling procedure for each MCS in an MCS table that is specific to probabilistic shaping. In some aspects, the power scaling factor may be an absolute power scaling factor (such as an explicitly defined or indicated power scaling factor). In some other aspects, the power scaling factor may be associated with a relative power scaling factor (such as a power scaling factor that is to be applied in combination with a second power scaling factor that is defined or indicated for a uniform distribution of constellation points). In some other aspects, the power scaling factor may be a calculated power scaling factor that depends on one or more probabilistic shaping parameters.

Further, in some implementations, the transmitting device and the receiving device may use a second power scaling procedure for a retransmission associated with probabilistic shaping, where such a second power scaling procedure may account for a possibility of probabilistically shaped retransmissions to include shaped constellation points, unshaped constellation points, or any combination thereof (as the retransmission may include at least some unshaped parity bits). The second power scaling procedure may include a use of a single power scaling factor for both the shaped and unshaped constellation points or a use of separate power scaling factors for the shaped constellation points and the unshaped constellation points. Additionally, or alternatively, the second power scaling procedure may include an exclusive selection of unshaped constellation points or an interleaving or scrambling of bits or selected constellation points such that transmitted modulation symbols (which may correspond to the selected constellation points) are effectively associated with a uniform distribution.

Particular implementations of the subject matter described in this disclosure can be implemented to realize one or more of the following potential advantages. For example, in accordance with supporting one or more power scaling procedures associated with transmissions that involve probabilistic shaping, a transmitting device and a receiving device may obtain mutually understood information relating to what power scaling factor is used for a given signal transmission while maintaining a target average transmit power and achieving the relatively high information rate associated with probabilistic shaping (such as probabilistic amplitude shaping). Further, as a result of both the transmitting device and the receiving device obtaining mutually understood information relating to what power scaling factor is used, the receiving device may have a greater likelihood of successfully demodulating and decoding the signal. As such, the transmitting device and the receiving device may experience higher reliability, higher data rates, greater system capacity, and greater spectral efficiency, among other benefits.

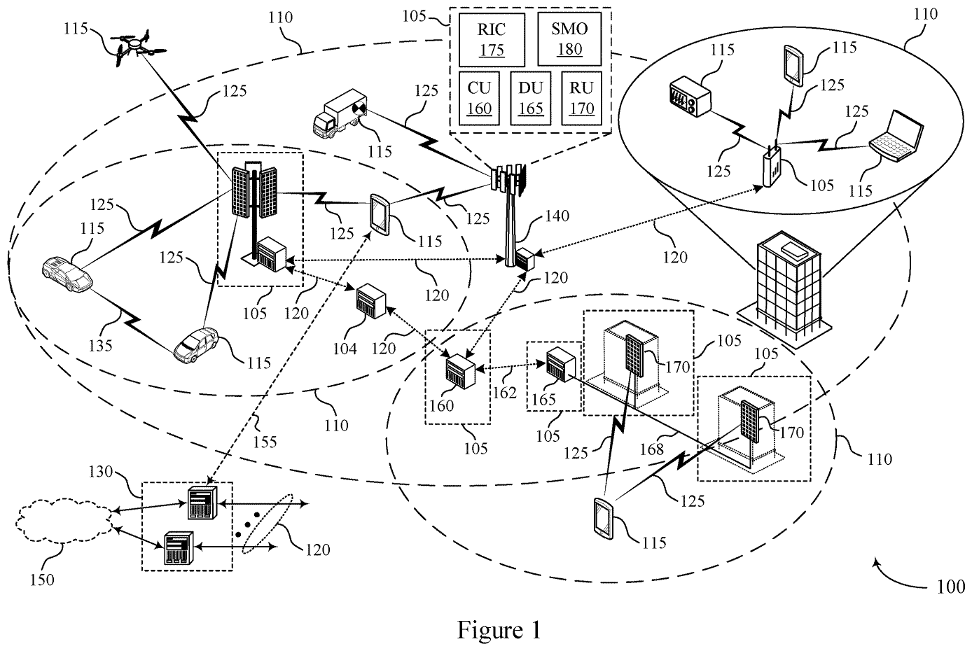

FIG. 1 shows an example wireless communications system 100 that supports power scaling factor selection techniques for probabilistically shaped systems. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another via a backhaul communication link 120 (such as in accordance with an X2, Xn, or other interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 via a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending upon which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication via such communication links.

In wireless communications systems (such as wireless communications system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (vIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

In the implementation of the techniques described herein applied in the context of a disaggregated RAN architecture, one or more components of the disaggregated RAN architecture may be configured to support power scaling factor selection techniques for probabilistically shaped systems as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUS 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, for which the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

The time intervals for the network entities 105 or the UEs 115 may be expressed in multiples of a basic time unit which may, in some implementations, refer to a sampling period of Ts=1/(Δƒₘₐₓ·N_{ƒ}) seconds, for which Δƒₘₐₓ may represent a supported subcarrier spacing, and Ns may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (such as N_{ƒ}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs 115 via a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by (such as scheduled by) the network entity 105. In some implementations, one or more UEs 115 of such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (such as less than 100 kilometers) compared to communications using the smaller frequencies and longer waves of the high frequency (HF) or very high frequency (VHF) portion of the spectrum below 300 MHz.

The wireless communications system 100 also may operate using a super high frequency (SHF) region, which may be in the range of 3 GHz to 30 GHZ, also known as the centimeter band, or using an extremely high frequency (EHF) region of the spectrum (such as from 30 GHz to 300 GHz), also known as the millimeter band. In some implementations, the wireless communications system 100 may support millimeter wave (mmW) communications between the UEs 115 and the network entities 105 (such as BSs 140, RUs 170), and EHF antennas of the respective devices may be smaller and more closely spaced than UHF antennas. In some implementations, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be associated with a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (such as a communication link 125, a D2D communication link 135). HARQ may include a combination of error detection (such as using a cyclic redundancy check (CRC)), forward error correction (FEC), and retransmission (such as automatic repeat request (ARQ)). HARQ may improve throughput at the MAC layer in poor radio conditions (such as low signal-to-noise conditions). In some implementations, a device may support same-slot HARQ feedback, for which the device may provide HARQ feedback in a specific slot for data received via a previous symbol in the slot. In some other examples, the device may provide HARQ feedback in a subsequent slot, or according to some other time interval.

In some wireless communications systems, such as the wireless communications system 100, communicating devices (such as one or more UEs 115 or one or more network entities 105, or any combination thereof) may employ probabilistic shaping. In some implementations, the communicating devices may employ a type of probabilistic shaping associated with shaping an amplitude of constellation points, which may be referred to herein as probabilistic amplitude shaping. In accordance with probabilistic amplitude shaping, constellation points, of a set of constellation points, that are associated with relatively higher or lower amplitudes may be selected for transmission relatively more or less often than if the set of constellation points were not associated with probabilistic amplitude shaping. For example, some modulation schemes, such as quadrature amplitude modulation (QAM) schemes, may be associated with fixed constellation points and such fixed constellation points may be associated with or referred to as square constellations and a transmitting device may select each constellation point with an equal probability (or an approximately equal probability). In some systems (such as a cellular or Wi-Fi system), higher-order modulation (such as 16 QAM, 64 QAM, 256 QAM, and the like) may be used to increase a spectral efficiency at relatively higher SNR values.

Uniform QAM may refer to a QAM scheme according to which each constellation point is associated with an equal probability of selection. For example, in terms of a transmitter flow (such as a process of steps associated with a transmission), a transmitting device may input an information payload into a channel coding step, scramble an output of the channel coding to obtain a set of uniformly distributed bits, input the set of uniformly distributed bits into a modulation step, and obtain a set of uniformly distributed QAM constellations as an output of the modulation. For example, in accordance with such a transmitter flow, different bit streams may be associated with different constellation points and a transmitting device may have an approximately equal probability of selecting a first constellation point from the set of QAM constellations as a second constellation point.

In an example bit sequence mapping for a 16 QAM signal, a bit stream of “0000” may map to a first constellation point, a bit stream of “0001” may map to a second constellation point, a bit stream of “0010” may map to a third constellation point, and so on (where the first, second, and third constellation points may be associated with different amplitudes or phases) and a transmitting device may have an approximately equal likelihood of selecting the first, second, and third constellation points for a transmission in accordance with using a uniformly distributed set of constellation points. Generally, a 4-bit stream may be denoted as b(0) b(1) b(2) b(3), where b(0) b(2) may define a column in a constellation diagram and b(1) b(3) may define a row in the constellation diagram. Further, a distance along an axis from an origin of a constellation diagram associated with conveying 4 bits may be approximately 1/\sqrt{5} to a first row or column and approximately 3/\sqrt{5} to a second row or column, where such a distance may be associated or correlate with an amplitude and transmit power.

Uniform QAM and other uniform modulation schemes may suffer from shaping loss at relatively higher SNR values as compared to modulation schemes that involve probabilistic shaping. For example, using an information rate comparison, uniform quadrature phase shift keying (QPSK), uniform 16 QAM, uniform 64 QAM, and uniform 256 QAM may trail an information rate (such as a quantity of bits per channel use) for probabilistic shaping (associated with a configured or calculated constellation distribution) for some, if not all, SNR values.

Accordingly, in some implementations, communicating devices may employ probabilistic shaping, which may refer to a technique to generate non-uniformly distributed coded modulation symbols (such as constellation points), to further increase a spectral efficiency of a coded modulation. In other words, communicating devices may employ probabilistic shaping to increase (such as to maximize) an amount of information (such as an amount of mutual information, where mutual information may refer to a measure of a mutual dependence between two or more variables) the devices are able to input or transmit in accordance with an input power constraint. As described herein, probabilistic shaping may take various forms, including probabilistic amplitude shaping. In deployment scenarios in which communicating devices employ probabilistic shaping, the communicating devices (such as a transmitting device and a receiving device) may use a power scaling procedure that is specific to or otherwise associated with probabilistic shaping (such as specific to or otherwise associated with probabilistic amplitude shaping). In some implementations, for example, communicating devices may support one or more procedures or considerations on power scaling for probabilistic shaping-based initial transmissions and retransmissions.

Further, a constellation point, a modulation symbol, and a modulated symbol may be used interchangeably herein. A constellation point may be associated with an I component and a Q component, where the I component may be associated with a real part of the constellation point and the Q component may be associated with an imaginary part of the constellation point. A constellation diagram or set may include a scattering or distribution of constellation points in a grid defined by a vertical imaginary axis representing the Q component and a horizontal real axis representing the I component. An angle of a point in a constellation diagram or set, which may be measured counterclockwise from the horizontal axis, may represent a phase shift of a carrier wave from a reference phase. A distance of a point from the origin may represent a measure of an amplitude or power of a signal.

In digital modulation systems, information may be transmitted as a series of samples, each sample occupying a uniform time duration. During each sample, the carrier wave may have a constant amplitude and phase (which may be constrained to one of a finite quantity of values). As such, each sample may encode one of a finite quantity of symbols, which in turn may represent one or more binary digits (such as bits) of information. Each symbol may be encoded as a different combination of amplitude and phase of the carrier, such that each symbol may be represented by a point on a constellation diagram or set, where such a point on a constellation diagram or set may be referred to as a constellation point. As such, a modulation or modulated symbol may refer to what is transmitted (such as over the air) and a constellation point corresponding to the modulation or modulated symbol may refer to a point on a constellation diagram or set that defines the amplitude and phase of the modulation or modulated symbol.

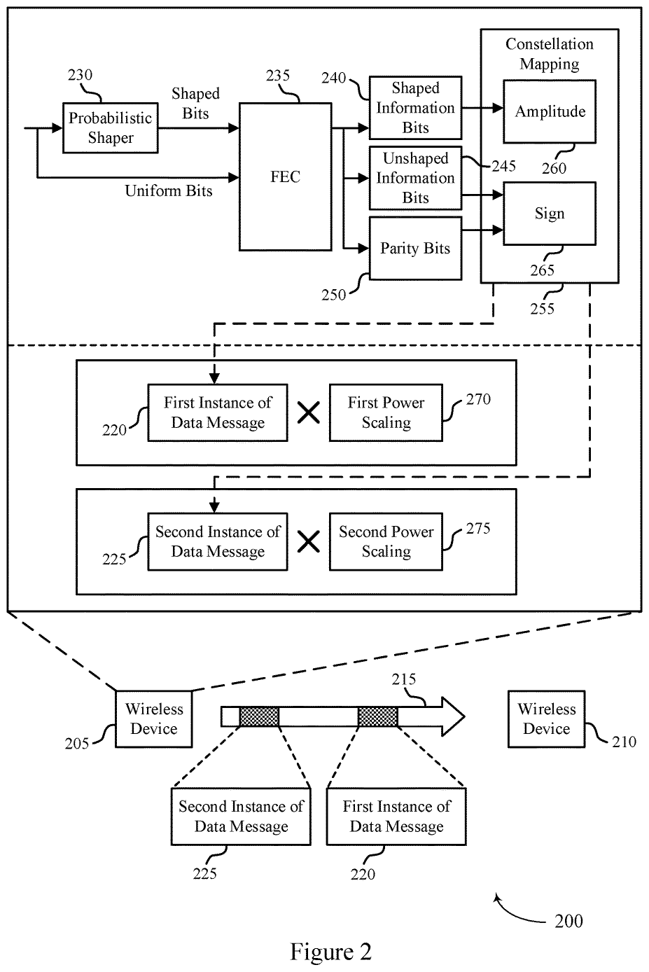

FIG. 2 shows an example signaling diagram 200 that supports power scaling factor selection techniques for probabilistically shaped systems. The signaling diagram 200 may implement or be implemented to realize aspects of the wireless communications system 100. For example, the signaling diagram 200 illustrates communication between a wireless device 205 and a wireless device 210 via a communication link 215. The wireless device 205 may be an example of a UE 115 or a network entity 105 as illustrated by and described with reference to FIG. 1. The wireless device 210 may be an example of a UE 115 or a network entity 105 as illustrated by and described with reference to FIG. 1. In some implementations, the wireless device 205 and the wireless device 210 may support one or more power scaling procedures that are dedicated for, specific to, or otherwise associated with probabilistic shaping-based transmissions and retransmissions.

For example, power scaling for a transmission that is associated with a uniform distribution of constellation points (such as uniform QAM) may be different from power scaling for a transmission that is associated with probabilistic shaping because constellations may no longer be uniformly distributed and because power scaling factors that are supported for uniform distributions of constellation points are designed in accordance with an expectation of such uniform distributions. For uniform QAM, a scaling factor may be defined or configured such that uniformly distributed QAM signals have an average power equal to 1. Further, for a QAM constellation (a complex constellation), a real part and an imaginary part may both be associated with a pulse-amplitude modulation (PAM) scheme and may be independent of each other.

In some aspects, power scaling factors for uniform QAM schemes may be defined or indicated for each MCS or for each QAM modulation order. For example, for 16 QAM, quadruplets of bits, such as b(4i), b(4i+1), b(4i+2), b(4i+3), may be mapped to complex-valued modulation symbols d (i) in accordance with Equation 1, shown below, where 1/\sqrt{10} is a power scaling factor.

$$d ( i ) = \frac{1}{\sqrt{10}} \{ ( 1 - 2 b ( 4 i ) ) [ 2 - ( 1 - 2 b ( 4 i + 2 ) ) ] + j ( 1 - 2 b ( 4 i + 1 ) ) [ 2 - ( 1 - 2 b ( 4 i + 3 ) ) ] \} \qquad ( 1 )$$

For 64 QAM, sextuplets of bits, such as b(6i), b(6i+1), b(6i+2), b(6i+3), b(6i+4), b(6i+5), may be mapped to complex-valued modulation symbols d (i) in accordance with Equation 2, shown below, where 1/\sqrt{42} is a power scaling factor.

$$\begin{matrix}d ( i ) = \frac{1}{\sqrt{42}} \{ ( 1 - 2 b ( 6 i ) ) [ 4 \\ - ( 1 - 2 b ( 6 i + 2 ) ) [ 2 - ( 1 - 2 b ( 6 i + 4 ) ) ] ] \\ + j ( 1 - 2 b ( 6 i + 1 ) ) [ 4 \\ - ( 1 - 2 b ( 6 i + 3 ) ) [ 2 - ( 1 - 2 b ( 6 i + 5 ) ) ] ] \}\end{matrix} \qquad ( 2 )$$

For 256 QAM, octuplets of bits, such as b(8i), b(8i+1), b(8i+2), b(8i+3), b(8i+4), b(8i+5), b(8i+6), b(8i+7), may be mapped to complex-valued modulation symbols d (i) in accordance with Equation 3, shown below, where 1/\sqrt{170} is a power scaling factor.

$$\begin{matrix}d ( i ) = \frac{1}{\sqrt{170}} \{ ( 1 - 2 b ( 8 i ) ) [ 8 \\ - ( 1 - 2 b ( 8 i + 2 ) ) [ 4 \\ - ( 1 - 2 b ( 8 i + 4 ) ) [ 2 - ( 1 - 2 b ( 8 i + 6 ) ) ] ] ] \\ + j ( 1 - 2 b ( 8 i + 1 ) ) [ 8 \\ - ( 1 - 2 b ( 8 i + 3 ) ) [ 4 \\ - ( 1 - 2 b ( 8 i + 5 ) ) [ 2 - ( 1 - 2 b ( 8 i + 7 ) ) ] ] ] \}\end{matrix} \qquad ( 3 )$$

In implementations in which the wireless device 205 and the wireless device 210 use probabilistic shaping to generate non-uniformly distributed constellations (which may achieve a larger mutual information I(X;Y) than uniformly distributed constellations at a same SNR), the wireless device 205 and the wireless device 210 may be unable to re-use the same power scaling factors that are defined or indicated for uniform QAM (as such power scaling factors may be defined or indicated on the basis of expected uniformity). For example, some probabilistic shaping techniques may include probabilistic amplitude shaping, which may include shaping amplitudes of constellations (such that constellations associated with relatively higher or lower amplitudes are selected relatively more or less often) and leaving signs of the constellations uniformly distributed.

In accordance with probabilistic shaping (such as probabilistic amplitude shaping), the wireless device 205 (such as a transmitting device) may split an information payload (such as a set of input bits associated with a data message) into two separate portions and may input a first portion into a probabilistic shaper 230. The probabilistic shaper 230 may be equivalently referred to as a distribution matcher and associated with distribution matching. The wireless device 205 may obtain a set of shaped bits as an output of the probabilistic shaper 230. A second portion of the information payload (such as the portion that the wireless device 205 refrains from inputting into to the probabilistic shaper 230) may remain unshaped or uniform. As such, the wireless device 205 may input a set of shaped bits (such as non-uniform bits) and a set of uniform bits into a forward error correction (FEC) encoder 235. The wireless device 205 may additionally input a set of parity bits into the FEC encoder 235 associated with the information payload. In some aspects, the FEC encoder 235 may be a high rate systematic FEC encoder.

The FEC encoder 235 may output a set of shaped information bits 240, a set of unshaped information bits 245, and a set of parity bits 250 (which also may be unshaped). The wireless device 205 may employ a constellation mapping 255 to map the set of shaped information bits 240 to an amplitude 260 of one or more constellation points and to map the set of unshaped information bits 245 and the set of parity bits 250 to a sign 265 of one or more constellation points. As such, for a given constellation point, an amplitude of the constellation point may be shaped while a sign of the constellation point remains unshaped (and associated with a uniform distribution). In some aspects, the constellation mapping 255 may be associated with a QAM modulation and an output of the QAM modulation may be uniformly distributed QAM constellations.

Probabilistically shaped systems may use or be associated with various different distributions of constellation points. In some implementations, the wireless device 205 and the wireless device 210 may employ a Maxwell-Boltzmann distribution, which may be characterized by a shaping parameter v. In accordance with a Maxwell-Boltzmann distribution, a probability of each constellation point s (of PAM) may be defined in accordance with Equations 4-6, shown below.

$$p ( s ) = \frac{{e}^{- v \vert s {\vert}^{2}}}{Z} \qquad ( 4 )$$

$$s = {s}_{re} + j \cdot {s}_{im} ∈ {C}_{m} \qquad ( 5 )$$

$$Z = {\sum }_{{s}^{′} ∈ {C}_{m}} {e}^{- v {\vert {s}^{′} \vert}^{2}} \qquad ( 6 )$$

In some aspects, Z may be chosen or selected such that the probability terms p(s) in Equation 4 sum to 1. Cm may denote the set of constellation points of a modulation order Qₘ, where Qₘ=4,6, 8, 10 for mQAM, with m=16, 64, 256, 1024, respectively. Further, sᵣₑ, sᵢₘ ∈ {±1, ±3, ±5, . . . } may be a real part or an imaginary part, respectively, of an un-normalized constellation point. In some aspects, for Maxwell-Boltzmann distribution, a set of bits that map to a same constellation may not necessarily be independent. For example, the set of bits may be jointly shaped and not marginalizable. Further, in some aspects, for square QAM, the real part and the imaginary part of the constellations may be independently and identically distributed (i.i.d.). As such, an alternative approach to define the Maxwell-Boltzmann distribution may be to define (such as exclusively define) the distribution on the real part (such as the PAM) and apply or expect a same distribution on the imaginary part.

For an arbitrary distribution p of (such as imposed on) a constellation set Cm, a power scaling factor may be applied to the constellation points such that an average power of the constellation points is equal to 1. Such a power scaling factor may be denoted as n and may be defined in accordance with Equation 7, shown below. As such, and in accordance with (such as after) normalization, an actual set of constellation points d may be defined in accordance with Equation 8, also shown below.

$$η = {\sum }_{s ∈ {C}_{m}} p ( s ) {\vert s \vert}^{2} \qquad ( 7 )$$

$$d = \frac{s}{\sqrt{η}} = \frac{{s}_{re} + j \cdot {s}_{im}}{\sqrt{η}} \qquad ( 8 )$$

In some implementations, the wireless device 205 (such as a transmitter) and the wireless device 210 (such as a receiver) may support one or more power scaling procedures to support power scaling for transmissions involving probabilistic shaping. In accordance with such power scaling procedures, the wireless device 205 and the wireless device 210 may achieve synchronization relating to which scaling factor is used by the wireless device 205, which may enable the wireless device 210 to successfully demodulate a transmitted signal. In some implementations, the wireless device 205 and the wireless device 210 may employ a first power scaling 270 for a first instance of a data message 220 (such as an initial transmission of a packet or data message) and may employ a second power scaling 275 for a second instance of the data message 225 (such as a retransmission of the packet or data message). Such a data message or packet may equivalently be referred to as a transport block.

At least for the initial transmission of a packet, the wireless device 205 and the wireless device 210 may support a storage or indication of a power scaling factor (associated with the first power scaling 270) that is defined for each MCS of an MCS table. In some implementations, such a power scaling factor associated with the first power scaling 270 may be referred to as an absolute scaling factor n (such as an explicitly indicated scaling factor). For example, the wireless device 205 and the wireless device 210 may support one or more MCS tables that are dedicated for or specifically associated with probabilistic shaping (such as probabilistic amplitude shaping). As such, the wireless device 205 and the wireless device 210 may select or otherwise identify an MCS table that is specifically associated with probabilistic shaping and may select a power scaling factor n from the selected or identified MCS table in accordance with an MCS (such as a coded modulation scheme or MCS index) to be used for the first instance of the data message 220. In other words, an MCS table that is specifically associated with probabilistic shaping may include one or more power scaling factors that are associated with (such as dedicated or exclusively used for) probabilistically shaped transmissions (such as the first instance of the data message 220). Accordingly, the wireless device 205 may apply the absolute scaling factor n to the first instance of the data message 220 in accordance with the first power scaling 270. In some aspects, applying the power scaling factor η may include multiplying a set of constellation points by 1/\sqrt{η}.

Additionally, or alternatively, the wireless device 205 and the wireless device 210 may support an indication or storage of a relative power scaling factor for each MCS, where the relative power scaling factor may be relative to a power scaling factor used for transmissions associated with a uniform distribution of constellation points (such as a power scaling factor used for uniform QAM). In such implementations, the wireless device 205 and the wireless device 210 may select or otherwise identify an MCS table, may select a relative power scaling factor \tilde{η} from the selected or identified MCS table in accordance with an MCS (such as a coded modulation scheme or MCS index) to be used for the first instance of the data message 220, and may select, calculate, or otherwise determine a power scaling factor n using the relative power scaling factor \tilde{η}. For example, if 16 QAM is used, a scaling factor for uniform QAM may be 10. As such, if an absolute scaling factor for a specific MCS is n, the relative power scaling factor \tilde{η} may be defined and indicated in an MCS table such that \tilde{η}=η/10. As such, the wireless device 205 may apply a power scaling factor η=\sqrt{\tilde{η}*10} (where 10 may be substituted out for any second power scaling factor associated with a uniform distribution of constellation points, such as 42 or 170). Applying the power scaling factor n may thus include multiplying a set of constellation points by 1/\sqrt{\tilde{η}*10} (at least for the example of 16 QAM). Further, in such examples, the wireless device 210 (such as a receiver) may implement a demodulator assuming a uniform distribution of constellation points (such as a uniform QAM) and may scale a received signal y using 1/\sqrt{\tilde{η}}. For example, the wireless device 210 may receive the first instance of the data message 220 as a signal y, demodulate the first instance of the data message 220 in accordance with a uniform QAM demodulation technique, and scale the signal using 1/\sqrt{\tilde{η}}.

Additionally, or alternatively, a relative power scaling factor \tilde{η} may be signaled or indicated from the wireless device 205 (a transmitter) to the wireless device 210 (a receiver) using a transmission of a reference signal, such as a demodulation reference signal (DMRS). For example, the wireless device 205 may transmit a DMRS associated with a probabilistically shaped transmission and may apply a power scaling factor of 1/\sqrt{\tilde{η}} to the DMRS. In other words, the wireless device 205 may power-boost the DMRS by 1/\sqrt{\tilde{η}}. As such, the wireless device 210 may estimate \tilde{η} in accordance with receiving the DMRS (instead of or in addition to calculating or selecting the relative power scaling factor \tilde{η} via other means, such as by selecting from an MCS table). The wireless device 210 may equalize a received signal associated with the first instance of the data message 220 in accordance with applying the relative power scaling factor \tilde{η} (such as by “de-boosting” the received signal by \tilde{η}).

Additionally, or alternatively, the wireless device 205 and the wireless device 210 may support a power scaling factor for the first power scaling 270 that is selected, identified, calculated, derived, or otherwise determined (by one or both of the wireless device 205 and the wireless device 210) in accordance with one or more probabilistic shaping parameters. In other words, the wireless device 205 and the wireless device 210 may calculate a power scaling factor associated with the first power scaling 270 in accordance with one or more shaping parameters associated with probabilistic amplitude shaping. The one or more shaping parameters may include at least one of a probability distribution scaling factor, a shaping rate, or an entropy value associated with one or more modulation symbols used for the first instance of the data message 220. In some implementations, such as implementations in which an input distribution follows a Maxwell-Boltzmann distribution, the wireless device 205 and the wireless device 210 may compute a power scaling factor in accordance with a shaping parameter v (which may be equivalently referred to as the probability distribution scaling factor) using any one or more of Equations 4-8.

A shaping rate may denote a ratio between a quantity of bits prior to probabilistic shaping and a quantity of bits after probabilistic shaping. For example, if a quantity of bits prior to probabilistic shaping is 800 bits and a quantity of bits after shaping is 1000 bits, the shaping rate may be R_{shaping}=800/1000=0.8. The shaping rate may be related to a source entropy (such as an entropy of one or more source symbols) in accordance with H (X)=Qₘ*R_{shaping}, where Qₘ may refer to a modulation order. As such, if the wireless device 205 and the wireless device 210 use a Maxwell-Boltzmann distribution as defined by Equation 4, the wireless device 205 and the wireless device 210 may find a shaping parameter v such that H (X)=Qₘ*R_{shaping} (such as Qₘ*0.8 in examples in which R_{shaping}=800/1000=0.8). Accordingly, the wireless device 205 and the wireless device 210 may calculate the power scaling factor using Equation 7.

In some aspects, the entropy value associated with the modulation symbols used for the first instance of the data message 220 may be associated with or otherwise referred to as an entropy value of one or more source symbols. For example, the entropy value may refer to an entropy or Shannon entropy of one or more modulated symbols that are associated with probability shaping (such as after probability shaping). The wireless device 205 or the wireless device 210, or both, may calculate the entropy value in accordance with Equation 9, shown below.

$$H ( X ) := - {\sum }_{x ∈ X} p ( x ) log p ( x ) = \text{?} [ - log p ( x ) ] \qquad ( 9 )$$

As shown in Equation 9, x may denote a modulation symbol, χ may denote a set of modulation symbols, p (x) may denote a probability mass function (PMF) of the modulation symbol x, and X may denote a variable (such as a random or target variable). Given a set or family of probability distributions on the set χ, and the entropy, the wireless device 205 or the wireless device 210 may calculate or obtain a power scaling factor. Further, Σ may denote a sum over the variable's (X's) possible values and [symbol] may be an expected value operator. A variance of the variable X, which may refer to a set of (random or selected) modulation symbols that are distributed according to an expected or target distribution, may denote the “power of modulated symbols” in accordance with a mean of X being equal to zero. In some aspects, the variance of X may denote the “power of modulated symbols” prior to an application of power scaling. Therefore, if the variance of X is relatively small, the power scaling factor may be relatively large to facilitate a final transmit power of the transmission being a constant that is independent of the probability distribution imposed on the modulated symbols.

Additionally, or alternatively, the wireless device 205 and the wireless device 210 may support a signaling mechanism or exchange according to which the wireless device 205 (a transmitter) may select, identify, calculate, derive, or otherwise determine a power scaling factor for the first power scaling 270 and transmit an indication (such as an explicit indication) of the power scaling factor to the wireless device 210 (a receiver). In some implementations, the wireless device 205 may explicitly indicate the power scaling factor in control information associated with the first instance of the data message 220. In such implementations, the indication of the power scaling factor may be separate (such as via a different field or set of bits) from an indication of an MCS. For example, the control information may include a control field that indicates the power scaling factor. The wireless device 205 may transmit the indication of the power scaling factor via uplink control information (UCI), downlink control information (DCI), sidelink control information (SCI), RRC signaling, or a MAC control element (MAC-CE).

Further, in some implementations, the power scaling factor that the wireless device 205 and the wireless device 210 use for the first power scaling 270 may be used regardless of an actual distribution of the transmitted symbols (such as the transmitted modulation symbols). In other words, the wireless device 205 and the wireless device 210 may refrain from using an actual distribution of the transmitted symbols to select, identify, calculate, or otherwise determine a power scaling factor for the first power scaling 270, as the wireless device 210 may be unaware of the actual distribution of the transmitted symbols. As such, the wireless device 205 and the wireless device 210 (generally, a transmitter and a receiver), may use, follow, or expect a same power scaling factor regardless of an actual distribution of the transmitted symbols, which may enable the wireless device 210 to successfully demodulate a signal (such as the first instance of the data message 220). For example, a first set of one or more constellation points may be associated with an amplitude of 1 and a design probability of 0.3 and a second set of one or more constellation points may be associated with an amplitude of 4 and a design probability of 0.7 but, for an actual n-modulation symbol transmission, 25% of the modulation symbols may have a power of 1 and 75% of the modulation symbols may have a power of 4. Thus, if the wireless device 205 uses an actual distribution of the modulation symbols to calculate a power scaling factor and the wireless device 210 uses a designed distribution of the modulation symbols to calculate a power scaling factor, the wireless device 205 and the wireless device 210 may select different power scaling factors, which may inhibit an ability of the wireless device 210 to successfully demodulate a signal (such as the first instance of the data message 220).

In some implementations, the wireless device 205 and the wireless device 210 may employ the second power scaling 275 as part of a transmission and a reception of the second instance of the data message 225, where the second instance of the data message 225 may be a retransmission of the first instance of the data message 220. In some scenarios, the second power scaling 275 may include aspects of or be the same as the first power scaling 270, but, in some other scenarios, the second power scaling 275 may be different from the first power scaling 270 in accordance with retransmission-specific considerations associated with probabilistic shaping. In other words, the first power scaling 270 may primarily be associated with the first instance of the data message 220 (such as a first or initial transmission of a transmission block or transport block) as, for a retransmission using incremental redundancy HARQ (IR-HARQ), the transmitted bits may be different from the bits conveyed via the initial transmission and, accordingly, a distribution of the transmitted modulation symbols also may be different. For example, for a retransmission, there may be a portion of the modulated symbols that has a non-uniform distribution (such as those that are modulated from shaped information bits 240) and another portion of the modulated symbols that includes modulation symbols that are uniformly distributed (such as those that correspond to unshaped information bits 245 or parity bits 250).

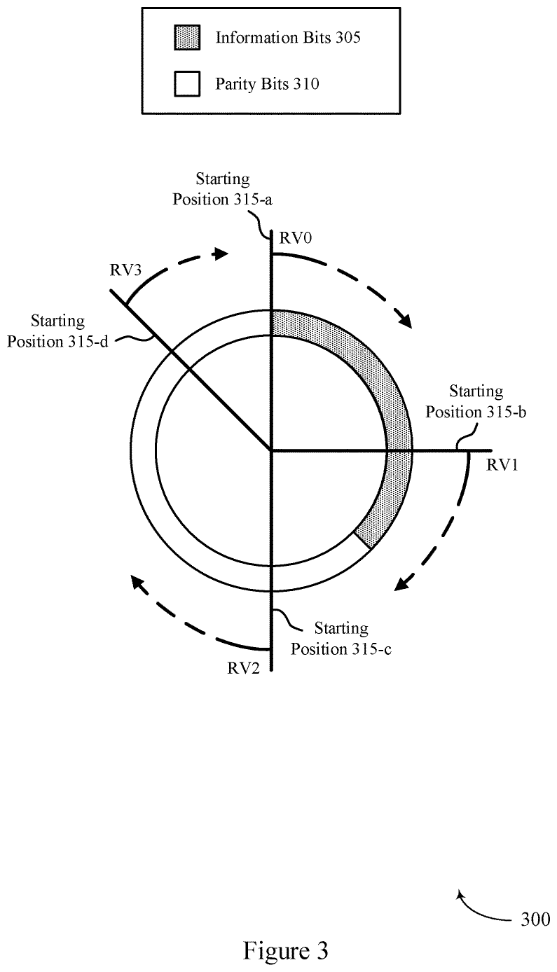

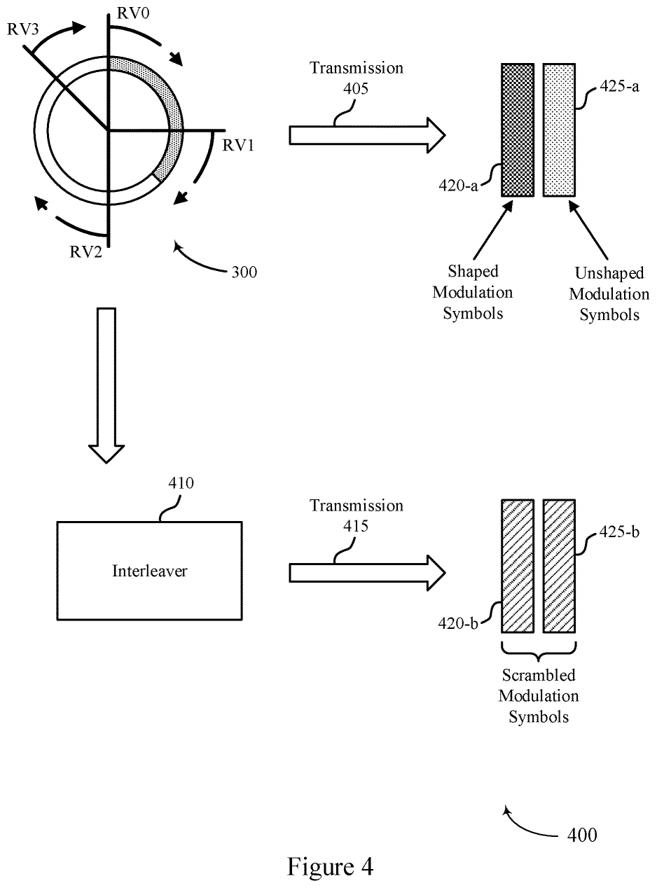

In some implementations, the second power scaling 275 may include a use of a single power scaling factor for both shaped and unshaped constellation points. In some other implementations, the second power scaling 275 may include a use of separate power scaling factors for each of shaped constellation points and unshaped constellation points. Additionally, or alternatively, the second power scaling 275 may include an exclusive selection of unshaped constellation points for the second instance of the data message 225 or an interleaving or scrambling of bits or selected constellation points such that the used modulation symbols (which correspond to the selected constellation points) are effectively associated with a uniform distribution. Additional details relating to the second power scaling 275 are illustrated by and described with reference to FIGS. 3 and 4.

FIG. 3 shows an example circular buffer 300 that supports power scaling factor selection techniques for probabilistically shaped systems. The circular buffer 300 may implement or be implemented to realize aspects of the wireless communications system 100 or the signaling diagram 200. For example, a wireless device 205 or a wireless device 210 (as illustrated by and described with reference to FIG. 2), or both, may maintain the circular buffer 300 and the wireless device 205 may select bits from the circular buffer 300 for a retransmission of a data message (such as for a second instance of a data message 225, as illustrated by and described with reference to FIG. 2). In some implementations, the wireless device 205 and the wireless device 210 may use aspects associated with the circular buffer 300 to select, identify, calculate, or otherwise determine one or more power scaling factors for a second power scaling (such as the second power scaling 275, as illustrated by and described with reference to FIG. 2) associated with a retransmission of a data message that is associated with probabilistic amplitude shaping.

The circular buffer 300 may include a set of information bits 305 (which may include a set of shaped information bits 240 and a set of unshaped information bits 245) and a set of parity bits 310. In accordance with performing a retransmission, the wireless device 205 may select a subset of bits from the circular buffer 300 and map the selected bits to constellation points and modulation symbols. In some aspects, the wireless device 205 may select bits starting from one of various starting positions 315 (which may generally refer to any one or more of a starting position 315-a, a starting position 315-b, a starting position 315-c, or a starting position 315-d), where different starting positions 315 may correspond to different redundancy versions (RVs). For example, if transmitting a message associated with an RV0 (such that RV=0), the device may select bits from the starting position 315-a. Further, if transmitting a messages associated with an RV1 (such that RV=1), an RV2 (such that RV=2), or an RV3 (such that RV=3), the wireless device 205 may select bits from the starting position 315-b, the starting position 315-c, or the starting position 315-d, respectively.

The wireless device 205 and the wireless device 210 may employ one or more methods or techniques associated with power scaling for probabilistic amplitude shaping with IR-HARQ. In some implementations, the wireless device 205 and the wireless device 210 may power scale a set of shaped constellation points and a set of unshaped constellation points separately. For example, the second instance of the data message 225 may include a set of shaped constellation points (corresponding to a set of shaped information bits 305) and a set of unshaped constellation points (corresponding to a set of unshaped information bits 305 or a set of parity bits 310, or any combination thereof) and the wireless device 205 and the wireless device 210 may apply different power scaling factors to each the set of shaped constellation points and the set of unshaped constellation points. In some implementations, the wireless device 205 and the wireless device 210 may apply the same scaling factor (which may be referred to as n shaped) as was used in an initial transmission to the set of shaped constellation points and may apply a second (and different) power scaling factor (which may be referred to as ηuniform) to the set of unshaped constellation points. In some implementations, the second power scaling factor may be a power scaling factor that corresponds to a uniform distribution of constellation points (such as uniform QAM). For example, the second power scaling factor may be equal to 10 for 16 QAM, 42 for 64 QAM, or 170 for 256 QAM.

In some other implementations, the wireless device 205 and the wireless device 210 may power scale the set of shaped constellation points and the set of unshaped constellation points jointly such that an average power across the set of shaped constellation points and the set of unshaped constellation points is equal to 1. In such implementations, the wireless device 205 and the wireless device 210 may compute a power scaling factor in accordance with an overall distribution of the constellations in the retransmission. Further, in such implementations, a joint power scaling factor may be signaled from the wireless device 205 (a transmitter) to the wireless device 210 (a receiver) or may be (implicitly) selected, calculated, identified, or otherwise determined by both the wireless device 205 and the wireless device 210 in accordance with a ratio between a quantity of shaped modulation symbols (which may correspond to a quantity of shaped constellation points) and a quantity of unshaped modulation symbols (which may correspond to a quantity of unshaped constellation points) included in the retransmission. In other words, a joint power scaling factor may be calculated in accordance with a comparison between the quantity of shaped symbols and the quantity of unshaped symbols included in the retransmission.

In some implementations in which a joint power scaling factor is applied, the joint power scaling factor may be between (in terms of relative values) what separate power scaling factors may otherwise be. In other words, a joint power scaling factor n may compare to a shaped constellations power scaling factor η_{shaped} and an unshaped constellations power scaling factor η_{uniform} such that η_{shaped}<η<ηuniform. As such, if a same power scaling factor is applied to both the shaped modulation symbols and the unshaped modulation symbols, the wireless device 205 may use different transmit powers for the one or more OFDM symbols that include (primarily or a majority of) shaped modulation symbols and for the one or more OFDM symbols that include (primarily or a majority of) unshaped modulation symbols. In some implementations, the wireless device 205 may apply an interleaver to distribute or scramble shaped and unshaped modulation symbols across a code block or transport block such that a portion of shaped and unshaped modulation symbols are approximately equal across each OFDM symbol used for the retransmission. Additional details associated with such an interleaver are illustrated by and described with reference to FIG. 4.

Additionally, or alternatively, the wireless device 205 and the wireless device 210 may support one or more techniques associated with uniformly distributing the modulation symbols in the retransmission. In some implementations, to facilitate such a uniform distribution, the wireless device 205 may refrain from selecting (such as ignore) any shaped bits from the circular buffer 300 for a retransmission. In such implementations, for example, the wireless device 205 may read unshaped bits from the circular buffer 300 for the retransmission and may ignore or skip over any shaped bits (such as any information bits 305 associated with probabilistic amplitude shaping).

In some aspects, the wireless device 205 or the wireless device 210 may determine whether to implement such a refrainment from selecting shaped bits from the circular buffer 300 in accordance with a potential loss of coding gain (and potentially further in accordance with channel conditions, latency constraints, or quality of service (QoS) constraints). For example, if the wireless device 205 and the wireless device 210 support limited buffer rate matching (LBRM), approximately two-thirds of a total quantity of bits in the circular buffer 300 may be shaped bits and approximately one-third of the total quantity of bits in the circular buffer 300 may be (unshaped) parity bits 310. As such, a retransmission may likely include a relatively large quantity of repetitions of information bits, and avoiding shaped bits in a retransmission may have a relatively large adverse impact on coding gain. Further, if more than one retransmission is performed (such as if an RV1, RV2, or RV3 is used), restricting a retransmission to unshaped bits (such as parity bits) may yield performance loss.

As such, the wireless device 205 or the wireless device 210 may consider such impacts of a refrainment from selecting shaped bits from the circular buffer 300 and may elect to adhere to the refrainment or employ a different technique accordingly. For example, if performance loss exceeds a threshold performance loss (in terms of coding gain or likelihood of successful reception), the wireless device 205 or the wireless device 210 may request, trigger, or use a different technique to obtain an approximately uniform distribution of constellation points or modulation symbols. Otherwise, the wireless device 205 and the wireless device 210 may refrain from selecting shaped bits from the circular buffer 300 for one or more retransmissions. In some aspects, the wireless device 205 and the wireless device 210 may refrain from selecting shaped bits from the circular buffer 300 for a first retransmission and may employ a different technique to obtain an approximately uniform distribution of constellation points or modulation symbols for any additional retransmissions.

Such a different technique to obtain an approximately uniform distribution of constellation points or modulation symbols may include a scrambling of the bits that are to be retransmitted. For example, for retransmissions (not corresponding to RV0), the wireless device 205 (the transmitter) may apply a scrambling to the bits that are to be retransmitted and, in this way, may change, adjust, or otherwise modify the distribution of the transmitted bits to be approximately uniformly distributed bits over {0, 1}, regardless of whether the bits are parity bits or information bits. As such, the resulting or corresponding modulated symbols also may be approximately uniformly distributed over the constellation set. Accordingly, both the wireless device 205 and the wireless device 210 may assume that uniform QAM modulation symbols are transmitted and, likewise, both the wireless device 205 and the wireless device 210 may use the same power scaling for the constellations as may be used for uniform QAM.

In other words, in accordance with scrambling the bits that are to be retransmitted, the wireless device 205 and the wireless device 210 may select a power scaling factor that is associated with a uniform distribution of constellation points (such as a power scaling factor that is associated with, or also used for, uniform QAM). The wireless device 210 (the receiver) may apply a demodulator corresponding to uniform QAM accordingly. Further, in accordance with such a scrambling of the bits that are to be retransmitted, the wireless device 205 and the wireless device 210 may avoid changing a circular buffer design (which may reduce complexity and processing costs) and may achieve relatively greater coding gain. For example, for a given retransmission, the wireless device 205 and the wireless device 210 may achieve greater coding gain in accordance with scrambling the bits that are to be retransmitted as compared to refraining from transmitting any shaped bits.

In some implementations, the wireless device 205 and the wireless device 210 may use different power scaling techniques for different retransmissions. In other words, the wireless device 205 and the wireless device 210 may select a power scaling technique for a retransmission in accordance with an RV index associated with the retransmission. For example, if a retransmission is associated with an RV1 or an RV2 (such that if RV1 or RV2 is scheduled), the wireless device 205 and the wireless device 210 may either refrain from transmitting shaped bits or may apply a scrambling to the bits that are to be retransmitted. If a retransmission is associated with an RV3 (such that RV3 is scheduled), the wireless device 205 and the wireless device 210 may apply separate power scaling factors, a joint power scaling factor, or an interleaver to distribute shaped and unshaped modulations across a code block or a transport block. As such, in some implementations, the wireless device 205 and the wireless device 210 may apply a first power scaling procedure for an initial transmission, a second power scaling procedure for a first retransmission, a third power scaling procedure for a second retransmission, and so on.

FIG. 4 shows example transmission schemes 400 that support power scaling factor selection techniques for probabilistically shaped systems. The transmission schemes 400 may implement or be implemented to realize aspects of the wireless communications system 100, the signaling diagram 200, or the circular buffer 300. For example, a transmitter (such as the wireless device 205) may employ aspects of the transmission schemes 400 to avoid a power imbalance issue associated with a retransmission that involves both shaped modulation symbols and unshaped modulation symbols.

For example, in implementations in which the wireless device 205 and the wireless device 210 apply a single or joint power scaling factor to a retransmission (such as the second instance of the data message 225), the wireless device 205 may use unequal transmit powers between a first set of one or more OFDM symbols that include or are otherwise associated with one or more shaped modulation symbols and a second set of one or more OFDM symbols that include or are otherwise associated with one or more unshaped modulation symbols. For example, the wireless device 205 may select information bits 305 and parity bits 310 from the circular buffer 300 (which may be an example of the circular buffer 300 as illustrated by and described with reference to FIG. 3) and may perform a transmission 405. If the wireless device 205 applies a single or joint power scaling factor as part of the transmission 405, the wireless device 205 may use a first transmit power during a first OFDM symbol 420-a that includes relatively more shaped modulation symbols and may use a second transmit power during a second OFDM symbol 425-a that includes relatively more unshaped (such as uniformly distributed) modulation symbols. Such a power imbalance between the first set of OFDM symbols and the second set of OFDM symbols may be problematic for the wireless device 205, especially in scenarios in which the wireless device 205 is transmitting using an uplink.

Accordingly, in some implementations, the wireless device 205 may apply an interleaver 410 to equalize (such as to randomize or approximately randomize) a distribution of the shaped modulation symbols and the unshaped modulation symbols across a code block or a transport block. The interleaver 410 may be a bit-level interleaver or a modulation symbol-level interleaver such that the wireless device 205 may scramble, distribute, or approximately randomize either shaped and unshaped bits or shaped and unshaped modulation symbols across a code block or a transport block. The wireless device 205 may perform a transmission 415 using the scrambled, distributed, or randomized bits or modulation symbols accordingly. As such, the relative amounts of shaped modulation symbols and unshaped modulation symbols may be approximately the same across a set of OFDM symbols, such as across a first OFDM symbol 420-b and a second OFDM symbol 425-b. Likewise, the wireless device 205 may use an approximately same transmit power across the first OFDM symbol 420-b and the second OFDM symbol 425-b while still using a single or joint power scaling factor across both shaped and unshaped constellation points.

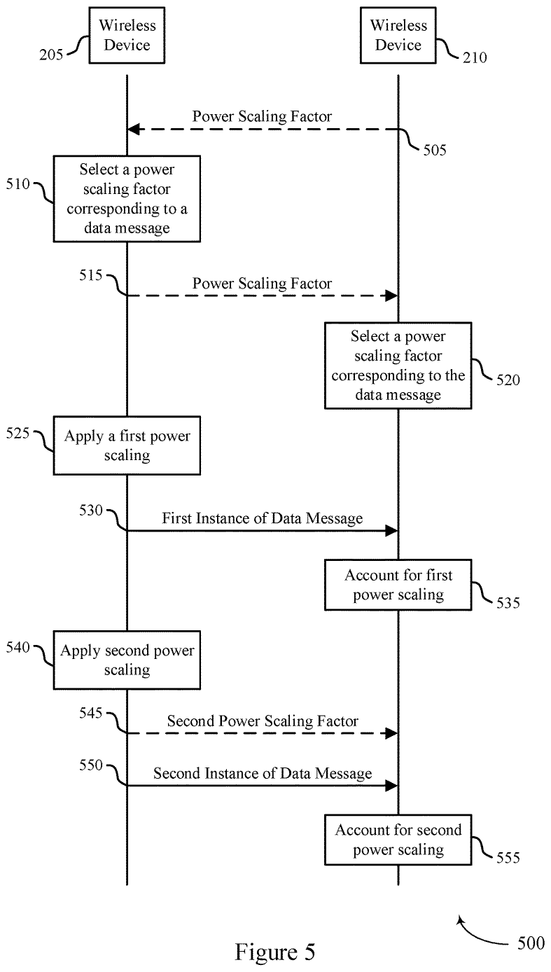

FIG. 5 shows an example process flow 500 that supports power scaling factor selection techniques for probabilistically shaped systems. The process flow 500 may implement or be implemented to realize aspects of the wireless communications system 100, the signaling diagram 200, the circular buffer 300, or the transmission schemes 400. For example, the process flow 500 illustrates communication between a wireless device 205 and a wireless device 210, which may be examples of the wireless device 205 and the wireless device 210, respectively, as illustrated by or described with reference to FIGS. 1-4. In some implementations, the wireless device 205 and the wireless device 210 may support one or more power scaling procedures that are dedicated for, specific to, or otherwise associated with probabilistic amplitude shaping-based transmissions and retransmissions.

In the following description of the process flow 500, the operations may be performed (such as reported or provided) in a different order than the order shown, or the operations performed by the example devices may be performed in different orders or at different times. For example, specific operations also may be left out of the process flow 500, or other operations may be added to the process flow 500. Further, although some operations or signaling may be shown to occur at different times for discussion purposes, these operations may actually occur at the same time.

At 505, the wireless device 210 may, in some implementations, transmit an indication of a power scaling factor to the wireless device 205, the indicated power scaling factor being specifically associated with power scaling transmissions involving a probabilistic shaping scheme (such as probabilistic amplitude shaping).

At 510, the wireless device 205 may select, according to a coded modulation scheme associated with a data message and a probabilistic shaping scheme associated with information bits of the data message, a power scaling factor corresponding to the data message. In some implementations, the wireless device 205 may select the power scaling factor indicated by the wireless device 210 at 505. In some implementations, the wireless device 205 may select the power scaling factor from a set of power scaling factors associated with a set of MCS parameters. In such implementations, the set of power scaling factors may be associated with the probabilistic shaping scheme and the selected power scaling factor may be associated with an index into the set of MCS parameters that corresponds to the coded modulation scheme of the data message. In other words, the wireless device 205 may select a power scaling factor from an MCS table that is specifically associated with the probabilistic shaping scheme.

In some implementations, the wireless device 205 may select an intermediate power scaling factor from a set of power scaling factors associated with a set of MCS parameters and may select, identify, calculate, or otherwise determine the power scaling factor as a product of the intermediate power scaling factor and a second power scaling factor, the second power scaling factor being associated with a uniform distribution of constellation points. In some aspects, the set of power scaling factors may be associated with the probabilistic shaping scheme. In other words, the wireless device 205 may select an intermediate power scaling factor (such as a relative power scaling factor \tilde{η}) from an MCS table that is specifically associated with the probabilistic shaping scheme and may calculate the power scaling factor n as a product of \tilde{η} and the second power scaling factor associated with a uniform distribution of constellation points (such as a power scaling factor selected from an MCS table that is specifically associated with uniform QAM and a same coded modulation scheme as the data message). As such, the intermediate power scaling factor may be a quotient of the power scaling factor n and the second power scaling factor associated with the uniform distribution.

In some implementations, the wireless device 205 may calculate the power scaling factor in accordance with one or more shaping parameters associated with the probabilistic shaping scheme. For example, the wireless device 205 may use at least one of a probability distribution scaling factor v, a shaping rate, or an entropy value associated with one or more modulation symbols used for the data message.

At 515, the wireless device 205 may, in some implementations, transmit an indication (such as an explicit indication) of the power scaling factor to the wireless device 210. Additionally, or alternatively, the wireless device 205 may transmit an implicit indication of the power scaling factor to the wireless device 210. For example, the wireless device 205 may indicate the power scaling factor by applying a (relative) power scaling factor to a reference signal (such as a DMRS) associated with the data message. In such examples, the wireless device 210 may receive the reference signal from the wireless device 205 and measure the (relative) power scaling factor in accordance with receiving the reference signal transmission.

At 520, the wireless device 210 may select, according to a coded modulation scheme associated with a data message and a probabilistic shaping scheme associated with information bits of the data message, the power scaling factor corresponding to the data message. In some implementations, the wireless device 205 and the wireless device 210 may select a same power scaling factor in accordance with supporting the power scaling procedures that are dedicated for, specific to, or otherwise associated with probabilistic amplitude shaping-based transmissions and retransmissions described herein. In some implementations, the wireless device 210 may select the power scaling factor in accordance with receiving an indication of the power scaling factor from the wireless device 205 at 515. Additionally, or alternatively, the wireless device 210 may select the power scaling factor from an MCS table that is specifically associated with the probabilistic shaping scheme, or in accordance with selecting a relative power scaling factor from an MCS table that is specifically associated with the probabilistic shaping scheme, or in accordance with a calculation using one or more shaping parameters associated with the probabilistic shaping scheme.

At 525, the wireless device 205 may apply a first power scaling to the data message (such as to a first or initial instance of the data message) according to the selected power scaling factor. For example, the wireless device 205 may select a power scaling factor n and may multiply a set of constellation points by 1/\sqrt{η}.

At 530, the wireless device 205 may transmit the data message (such as the first or initial instance of the data message) according to the coded modulation scheme. In some implementations, the transmission of the data message may include encoding the information bits of the data message according to the probabilistic shaping scheme and applying the power scaling to the data message according to the selected power scaling factor. Likewise, the wireless device 210 may receive the data message (such as the first or initial instance of the data message) according to the coded modulation scheme. In some implementations, the reception of the data message may include decoding the information bits according to the probabilistic shaping scheme and accounting for the power scaling of the data message according to the power scaling factor.

At 535, for example, the wireless device 210 may account for the first power scaling applied to the first instance of the data message. In some implementations, the wireless device 210 may account for the selected power scaling factor n in accordance with removing an impact of a 1/\sqrt{n} factor that the wireless device 210 expects to have been applied to the first instance of the data message. For example, the wireless device 210 may apply an inverse of the power scaling factor to the received modulation symbols.

In some implementations, the wireless device 205 and the wireless device 210 may perform and expect, respectively, a second instance of the data message as a retransmission of the data message. For example, the wireless device 210 may fail to successfully receive the first instance of the data message or the wireless device 205 may proactively perform one or more retransmissions of the data message to increase the likelihood of the wireless device 210 successfully receiving and decoding the data message. Accordingly, the wireless device 205 and the wireless device 210 may employ one or more techniques associated with power scaling the second instance of the data message in accordance with the probabilistic shaping scheme associated with the information bits of the data message.

At 540, the wireless device 205 may apply a second power scaling to the second instance of the data message. In some implementations, the wireless device 205 may apply the same power scaling factor used for the first instance of the data message to a first portion of the second instance of the data message and may apply a second (different) power scaling factor to a second portion of the second instance of the data message, where the first portion corresponds to a set of shaped constellation points and the second portion corresponds to a set of unshaped constellation points. In some other implementations, the wireless device 205 may apply a single or joint power scaling factor to both the shaped constellation points and the unshaped constellation points. In some implementations, the wireless device 205 may scramble the set of shaped constellation points and the set of unshaped constellation points across one or both of a code block or a transport block associated with the second instance of the data message. In some other implementations, the wireless device 205 may select bits from a circular buffer to avoid shaped bits. In such implementations, the wireless device 205 may transmit the second instance of the data message excluding shaped constellation points and may use a power scaling factor associated with a uniform distribution of constellation points. In some implementations, the wireless device 205 may scramble a set of bits to be transmitted such that shaped constellation points and unshaped constellation points are distributed across a constellation set in such a way that enables the wireless device 205 to use a power scaling factor associated with a uniform distribution of constellation points.

At 545, the wireless device 205 may, in some implementations, transmit an indication of the second power scaling factor or an indication of the second power scaling to be applied to the second instance of the data message to the wireless device 210.

At 550, the wireless device 205 may transmit the second instance of the data message to the wireless device 210. In some implementations, transmitting the second instance of the data message may include applying the second power scaling at 540. The wireless device 210 may likewise receive the second instance of the data message. In some implementations, receiving the second instance of the data message may include accounting for the second power scaling applied to the second instance of the data message.

At 555, for example, the wireless device 210 may account for the second power scaling of the second instance of the data message. In some implementations, the wireless device 210 may account for the second power scaling in accordance with expecting separate power scaling factors to have been applied by the wireless device 205 for shaped constellation points and unshaped constellation points, respectively, or in accordance with expecting a single, joint power scaling factor to have been applied by the wireless device 205 for both shaped and unshaped constellation points. As such, the wireless device 210 may apply inverses of the separate power scaling factors to the received shaped modulation symbols and the received unshaped modulation symbols, respectively, or may apply an inverse of a single power scaling factor to both the received shaped and unshaped modulation symbols.

Additionally, or alternatively, the wireless device 210 may unscramble the set of shaped constellation points and the set of unshaped constellation points across one or both of a code block or a transport block associated with the second instance of the data message. In some implementations, wireless device 210 may expect the second instance of the data message to exclude shaped constellation points in accordance with the second instance of the data message being a retransmission and the data message being associated with the probabilistic shaping scheme. In some implementations, the wireless device 210 may unscramble a set of bits received via the second instance of the data message, where the bits may have been scrambled by the wireless device 205 such that shaped constellation points and unshaped constellation points were distributed in such a manner to facilitate or allow a use of a power scaling factor associated with a uniform distribution of constellation points.

Further, in some implementations, the wireless device 205 and the wireless device 210 may support more than one retransmission of the data message. In such implementations, the wireless device 205 and the wireless device 210 may use a same power scaling technique for each retransmission or may use different power scaling techniques for different retransmissions of the data message.

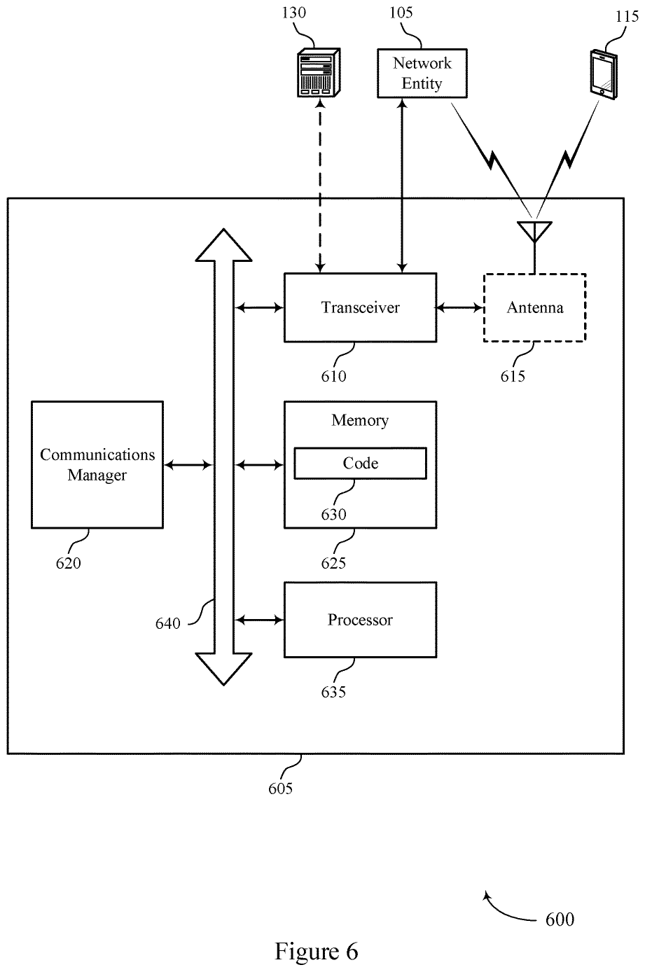

FIG. 6 shows a block diagram 600 of an example device 605 that supports power scaling factor selection techniques for probabilistically shaped systems. The device 605 may communicate with one or more network entities (such as one or more components of one or more network entities 105), one or more UEs 115, or any combination thereof, which may include communications over one or more wired interfaces, over one or more wireless interfaces, or any combination thereof. The device 605 may include components that support outputting and obtaining communications, such as a communications manager 620, a transceiver 610, an antenna 615, a memory 625, code 630, and a processor 635. These components may be in electronic communication or otherwise coupled (such as operatively, communicatively, functionally, electronically, electrically) via one or more buses (such as a bus 640). The device 605 may be an example of a UE 115 or a network entity 105 as illustrated by and described with reference to FIG. 1, or an example of a wireless device 205 or a wireless device 210 as illustrated by and described with reference to FIGS. 2-5.

The transceiver 610 may support bi-directional communications via wired links, wireless links, or both as described herein. In some implementations, the transceiver 610 may include a wired transceiver and may communicate bi-directionally with another wired transceiver. Additionally, or alternatively, in some implementations, the transceiver 610 may include a wireless transceiver and may communicate bi-directionally with another wireless transceiver. In some implementations, the device 605 may include one or more antennas 615, which may be capable of transmitting or receiving wireless transmissions (such as concurrently). The transceiver 610 also may include a modem to modulate signals, to provide the modulated signals for transmission (such as by one or more antennas 615, by a wired transmitter), to receive modulated signals (such as from one or more antennas 615, from a wired receiver), and to demodulate signals.

In some implementations, the transceiver 610 may include one or more interfaces, such as one or more interfaces coupled with the one or more antennas 615 that are configured to support various receiving or obtaining operations, or one or more interfaces coupled with the one or more antennas 615 that are configured to support various transmitting or outputting operations, or a combination thereof. In some implementations, the transceiver 610 may include or be configured for coupling with one or more processors or memory components that are operable to perform or support operations in accordance with received or obtained information or signals, or to generate information or other signals for transmission or other outputting, or any combination thereof. In some implementations, the transceiver 610, or the transceiver 610 and the one or more antennas 615, or the transceiver 610 and the one or more antennas 615 and one or more processors or memory components (such as the processor 635, or the memory 625, or both), may be included in a chip or chip assembly that is installed in the device 605. In some implementations, the transceiver may be operable to support communications via one or more communications links (such as a communication link 125, a backhaul communication link 120, a midhaul communication link 162, a fronthaul communication link 168).

The memory 625 may include random access memory (RAM) and read-only memory (ROM). The memory 625 may store computer-readable, computer-executable code 630 including instructions that, when executed by the processor 635, cause the device 605 to perform various functions described herein. The code 630 may be stored in a non-transitory computer-readable medium such as system memory or another type of memory. In some implementations, the code 630 may not be directly executable by the processor 635 but may cause a computer (such as when compiled and executed) to perform functions described herein. In some implementations, the memory 625 may contain, among other things, a basic input/output (I/O) system (BIOS) which may control basic hardware or software operation such as the interaction with peripheral components or devices.

The processor 635 may include an intelligent hardware device (such as a general-purpose processor, a digital signal processor (DSP), an application-specific integrated circuit (ASIC), a central processing unit (CPU), a field-programmable gate array (FPGA), a microcontroller, a programmable logic device, discrete gate or transistor logic, a discrete hardware component, or any combination thereof). In some implementations, the processor 635 may be configured to operate a memory array using a memory controller. In some other implementations, a memory controller may be integrated into the processor 635. The processor 635 may be configured to execute computer-readable instructions stored in a memory (such as the memory 625) to cause the device 605 to perform various functions (such as functions or tasks supporting power scaling factor selection techniques for probabilistically shaped systems). For example, the device 605 or a component of the device 605 may include a processor 635 and memory 625 coupled with the processor 635, the processor 635 and memory 625 configured to perform various functions described herein. The processor 635 may be an example of a cloud-computing platform (such as one or more physical nodes and supporting software such as operating systems, virtual machines, or container instances) that may host the functions (such as by executing code 630) to perform the functions of the device 605. The processor 635 may be any one or more suitable processors capable of executing scripts or instructions of one or more software programs stored in the device 605 (such as within the memory 625).

In some implementations, the processor 635 may be a component of a processing system. A processing system may generally refer to a system or series of machines or components that receives inputs and processes the inputs to produce a set of outputs (which may be passed to other systems or components of, for example, the device 605). For example, a processing system of the device 605 may refer to a system including the various other components or subcomponents of the device 605, such as the processor 635, or the transceiver 610, or the communications manager 620, or other components or combinations of components of the device 605. The processing system of the device 605 may interface with other components of the device 605, and may process information received from other components (such as inputs or signals) or output information to other components. For example, a chip or modem of the device 605 may include a processing system and an interface to output information, or to obtain information, or both.

The interface may be implemented as or otherwise include a first interface configured to output information and a second interface configured to obtain information. In some implementations, the first interface may refer to an interface between the processing system of the chip or modem and a transmitter, such that the device 605 may transmit information output from the chip or modem. In some implementations, the second interface may refer to an interface between the processing system of the chip or modem and a receiver, such that the device 605 may obtain information or signal inputs, and the information may be passed to the processing system. A person having ordinary skill in the art will readily recognize that the first interface also may obtain information or signal inputs, and the second interface also may output information or signal outputs.

In some implementations, a bus 640 may support communications of (such as within) a protocol layer of a protocol stack. In some implementations, a bus 640 may support communications associated with a logical channel of a protocol stack (such as between protocol layers of a protocol stack), which may include communications performed within a component of the device 605, or between different components of the device 605 that may be co-located or located in different locations (such as where the device 605 may refer to a system in which one or more of the communications manager 620, the transceiver 610, the memory 625, the code 630, and the processor 635 may be located in one of the different components or divided between different components).

In some implementations, the communications manager 620 may manage aspects of communications with a core network 130 (such as via one or more wired or wireless backhaul links). For example, the communications manager 620 may manage the transfer of data communications for client devices, such as one or more UEs 115. In some implementations, the communications manager 620 may manage communications with other network entities 105, and may include a controller or scheduler for controlling communications with UEs 115 in cooperation with other network entities 105. In some implementations, the communications manager 620 may support an X2 interface within an LTE/LTE-A wireless communications network technology to provide communication between network entities 105.

The communications manager 620 may support wireless communication at a wireless device in accordance with examples as disclosed herein. For example, the communications manager 620 may be configured as or otherwise support a means for selecting, according to a coded modulation scheme associated with a data message and a probabilistic shaping scheme associated with information bits of the data message, a power scaling factor corresponding to the data message. The communications manager 620 may be configured as or otherwise support a means for transmitting the data message according to the coded modulation scheme, including encoding the information bits according to the probabilistic shaping scheme and applying a power scaling to the data message according to the power scaling factor.

In some implementations, to support selecting the power scaling factor, the communications manager 620 may be configured as or otherwise support a means for selecting the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.

In some implementations, to support selecting the power scaling factor, the communications manager 620 may be configured as or otherwise support a means for selecting an intermediate power scaling factor from a set of power scaling factors associated with a set of MCS parameters, where the set of power scaling factors is associated with the probabilistic shaping scheme, where the power scaling factor is a product of the intermediate power scaling factor and a second power scaling factor, and where the second power scaling factor is associated with a uniform distribution of constellation points.

In some implementations, to support selecting the power scaling factor, the communications manager 620 may be configured as or otherwise support a means for calculating the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.

In some implementations, the communications manager 620 may be configured as or otherwise support a means for transmitting a DMRS associated with the data message in accordance with the power scaling factor.

In some implementations, the communications manager 620 may be configured as or otherwise support a means for transmitting a second instance of the data message as a retransmission of the data message, where transmitting the second instance of the data message includes applying a second power scaling to the second instance of the data message.

In some implementations, to support applying the second power scaling to the second instance of the data message, the communications manager 620 may be configured as or otherwise support a means for applying the power scaling factor to a first portion of the second instance of the data message, where the first portion of the second instance of the data message corresponds to a set of shaped constellation points. In some implementations, to support applying the second power scaling to the second instance of the data message, the communications manager 620 may be configured as or otherwise support a means for applying a second power scaling factor to a second portion of the second instance of the data message, where the second portion of the second instance of the data message corresponds to set of unshaped constellation points.

In some implementations, to support applying the second power scaling to the second instance of the data message, the communications manager 620 may be configured as or otherwise support a means for applying a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.

In some implementations, the communications manager 620 may be configured as or otherwise support a means for transmitting, to a second wireless device, an indication of the second power scaling factor.

In some implementations, the communications manager 620 may be configured as or otherwise support a means for scrambling the set of shaped constellation points and the set of unshaped constellation points across one or both of a code block or a transport block associated with the second instance of the data message.

In some implementations, to support transmitting the second instance of the data message, the communications manager 620 may be configured as or otherwise support a means for transmitting a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.

In some implementations, the communications manager 620 may be configured as or otherwise support a means for scrambling a set of bits to be transmitted via the second instance of the data message, where the set of bits correspond to a set of shaped constellation points and a set of unshaped constellation points, and where the set of shaped constellation points and the set of unshaped constellation points are uniformly distributed across a constellation set in accordance with scrambling the set of bits, and where the second power scaling is associated with a uniform distribution of constellation points in accordance with scrambling the set of bits.

In some implementations, the communications manager 620 may be configured as or otherwise support a means for transmitting a third instance of the data message as a second retransmission of the data message, where transmitting the third instance of the data message includes applying a third power scaling to the second instance of the data message, where the third power scaling is different from the second power scaling.

In some implementations, the communications manager 620 may be configured as or otherwise support a means for transmitting, to a second wireless device, an indication of the power scaling factor.

In some implementations, to support selecting the power scaling factor, the communications manager 620 may be configured as or otherwise support a means for receiving, from a second wireless device, an indication of the power scaling factor.

Additionally, or alternatively, the communications manager 620 may support wireless communication at a wireless device in accordance with examples as disclosed herein. For example, the communications manager 620 may be configured as or otherwise support a means for selecting, according to a coded modulation scheme associated with a data message and a probabilistic shaping scheme associated with information bits of the data message, a power scaling factor corresponding to the data message. The communications manager 620 may be configured as or otherwise support a means for receiving the data message according to the coded modulation scheme, including decoding the information bits according to the probabilistic shaping scheme and accounting for a power scaling of the data message according to the power scaling factor.

In some implementations, to support selecting the power scaling factor, the communications manager 620 may be configured as or otherwise support a means for selecting the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.

In some implementations, to support selecting the power scaling factor, the communications manager 620 may be configured as or otherwise support a means for selecting an intermediate power scaling factor from a set of power scaling factors associated with a set of MCS parameters, where the set of power scaling factors is associated with the probabilistic shaping scheme, where the power scaling factor is a product of the intermediate power scaling factor and a second power scaling factor, where the second power scaling factor is associated with a uniform distribution of constellation points.

In some implementations, to support selecting the power scaling factor, the communications manager 620 may be configured as or otherwise support a means for calculating the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.

In some implementations, to support selecting the power scaling factor, the communications manager 620 may receive a DMRS associated with the data message and measure the power scaling factor in accordance with receiving the DMRS associated with the data message.

In some implementations, the communications manager 620 may be configured as or otherwise support a means for receiving a second instance of the data message as a retransmission of the data message, where receiving the second instance of the data message includes accounting for a second power scaling of the second instance of the data message.

In some implementations, to support accounting for the second power scaling of the second instance of the data message, the communications manager 620 may be configured as or otherwise support a means for applying an inverse of the power scaling factor to a first portion of the second instance of the data message, where the first portion of the second instance of the data message corresponds to a set of shaped constellation points. In some implementations, to support accounting for the second power scaling of the second instance of the data message, the communications manager 620 may be configured as or otherwise support a means for applying an inverse of a second power scaling factor to a second portion of the second instance of the data message, where the second portion of the second instance of the data message corresponds to set of unshaped constellation points.

In some implementations, to support accounting for the second power scaling of the second instance of the data message, the communications manager 620 may be configured as or otherwise support a means for applying an inverse of a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.

In some implementations, the communications manager 620 may be configured as or otherwise support a means for receiving, from a second wireless device, an indication of the second power scaling factor.

In some implementations, the communications manager 620 may be configured as or otherwise support a means for unscrambling the set of shaped constellation points and the set of unshaped constellation points across one or both of a code block or a transport block associated with the second instance of the data message.

In some implementations, to support receiving the second instance of the data message, the communications manager 620 may be configured as or otherwise support a means for receiving a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.

In some implementations, the communications manager 620 may be configured as or otherwise support a means for unscrambling a set of bits received via the second instance of the data message, where the set of bits correspond to a set of shaped constellation points and a set of unshaped constellation points, and where the set of shaped constellation points and the set of unshaped constellation points are uniformly distributed across a constellation set in accordance with unscrambling the set of bits, and where the second power scaling is associated with a uniform distribution of constellation points in accordance with unscrambling the set of bits.

In some implementations, the communications manager 620 may be configured as or otherwise support a means for receiving a third instance of the data message as a second retransmission of the data message, where receiving the third instance of the data message includes accounting for a third power scaling of the second instance of the data message, where the third power scaling is different from the second power scaling.

In some implementations, to support selecting the power scaling factor, the communications manager 620 may be configured as or otherwise support a means for receiving, from a second wireless device, an indication of the power scaling factor.

In some implementations, the communications manager 620 may be configured as or otherwise support a means for transmitting, to a second wireless device, an indication of the power scaling factor.

In some implementations, the communications manager 620 may be configured to perform various operations (such as receiving, obtaining, monitoring, outputting, transmitting) using or otherwise in cooperation with the transceiver 610, the one or more antennas 615 (such as where applicable), or any combination thereof. Although the communications manager 620 is illustrated as a separate component, in some implementations, one or more functions described with reference to the communications manager 620 may be supported by or performed by the processor 635, the memory 625, the code 630, the transceiver 610, or any combination thereof. For example, the code 630 may include instructions executable by the processor 635 to cause the device 605 to perform various aspects of power scaling factor selection techniques for probabilistically shaped systems as described herein, or the processor 635 and the memory 625 may be otherwise configured to perform or support such operations.

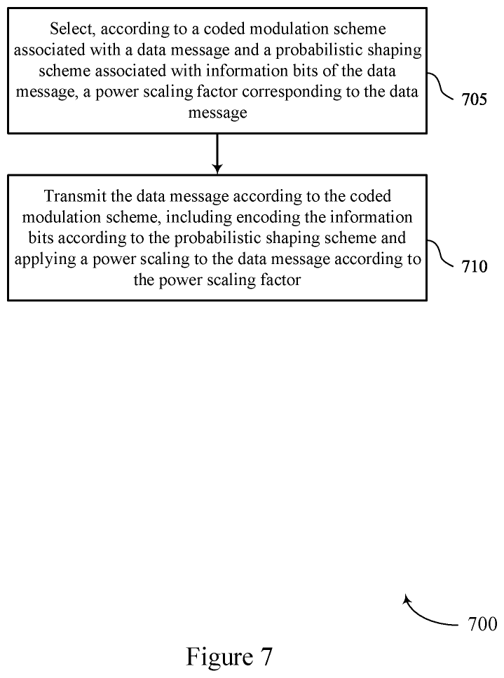

FIG. 7 shows a flowchart illustrating an example method 700 that supports power scaling factor selection techniques for probabilistically shaped systems. The operations of the method 700 may be implemented by a UE or a network entity or its components as described herein. For example, the operations of the method 700 may be performed by a UE 115 or a network entity as described with reference to FIGS. 1-6. In some implementations, a UE or a network entity may execute a set of instructions to control the functional elements of the UE or the network entity to perform the described functions. Additionally, or alternatively, the UE or the network entity may perform aspects of the described functions using special-purpose hardware.

At 705, the method may include selecting, according to a coded modulation scheme associated with a data message and a probabilistic shaping scheme associated with information bits of the data message, a power scaling factor corresponding to the data message. The operations of 705 may be performed in accordance with examples as disclosed herein.

At 710, the method may include transmitting the data message according to the coded modulation scheme, including encoding the information bits according to the probabilistic shaping scheme and applying a power scaling to the data message according to the power scaling factor. The operations of 710 may be performed in accordance with examples as disclosed herein.

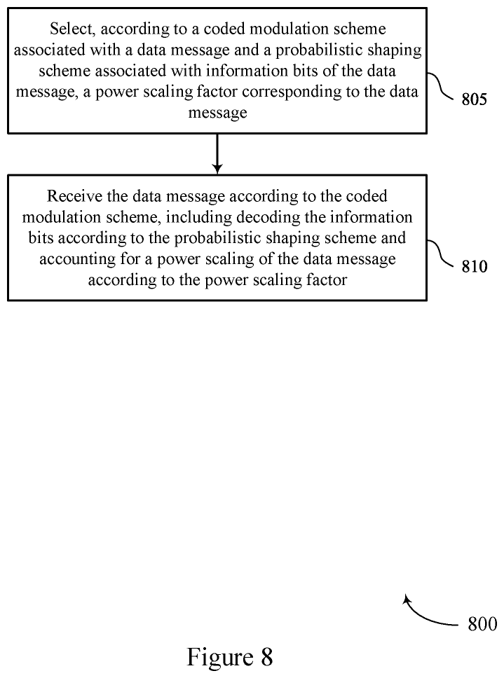

FIG. 8 shows a flowchart illustrating an example method 800 that supports power scaling factor selection techniques for probabilistically shaped systems. The operations of the method 800 may be implemented by a UE or a network entity or its components as described herein. For example, the operations of the method 800 may be performed by a UE 115 or a network entity as described with reference to FIGS. 1-6. In some implementations, a UE or a network entity may execute a set of instructions to control the functional elements of the UE or the network entity to perform the described functions. Additionally, or alternatively, the UE or the network entity may perform aspects of the described functions using special-purpose hardware.

At 805, the method may include selecting, according to a coded modulation scheme associated with a data message and a probabilistic shaping scheme associated with information bits of the data message, a power scaling factor corresponding to the data message. The operations of 805 may be performed in accordance with examples as disclosed herein.

At 810, the method may include receiving the data message according to the coded modulation scheme, including decoding the information bits according to the probabilistic shaping scheme and accounting for a power scaling of the data message according to the power scaling factor. The operations of 810 may be performed in accordance with examples as disclosed herein. The following provides an overview of some aspects of the present disclosure:
Aspect 1: A method for wireless communication at a wireless device, including: selecting, according to a coded modulation scheme associated with a data message and a probabilistic shaping scheme associated with information bits of the data message, a power scaling factor corresponding to the data message; and transmitting the data message according to the coded modulation scheme, including encoding the information bits according to the probabilistic shaping scheme and applying a power scaling to the data message according to the power scaling factor.
Aspect 2: The method of aspect 1, where selecting the power scaling factor includes: selecting the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.
Aspect 3: The method of aspect 1, where selecting the power scaling factor includes: selecting an intermediate power scaling factor from a set of power scaling factors associated with a set of MCS parameters, where the set of power scaling factors is associated with the probabilistic shaping scheme, where the power scaling factor is a quotient of the intermediate power scaling factor and a second power scaling factor, and where the second power scaling factor is associated with a uniform distribution of constellation points.
Aspect 4: The method of aspect 1, where selecting the power scaling factor includes: calculating the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.
Aspect 5: The method of any of aspects 1-4, further including: transmitting a demodulation reference signal associated with the data message in accordance with the power scaling factor.
Aspect 6: The method of any of aspects 1-5, further including: transmitting a second instance of the data message as a retransmission of the data message, where transmitting the second instance of the data message includes applying a second power scaling to the second instance of the data message.
Aspect 7: The method of aspect 6, where applying the second power scaling to the second instance of the data message includes: applying the power scaling factor to a first portion of the second instance of the data message, where the first portion of the second instance of the data message corresponds to a set of shaped constellation points; and applying a second power scaling factor to a second portion of the second instance of the data message, where the second portion of the second instance of the data message corresponds to set of unshaped constellation points.
Aspect 8: The method of aspect 6, where applying the second power scaling to the second instance of the data message includes: applying a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.
Aspect 9: The method of aspect 8, further including: transmitting, to a second wireless device, an indication of the second power scaling factor.
Aspect 10: The method of any of aspects 8-9, further including: scrambling the set of shaped constellation points and the set of unshaped constellation points across one or both of a code block or a transport block associated with the second instance of the data message.
Aspect 11: The method of aspect 6, where transmitting the second instance of the data message includes: transmitting a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.
Aspect 12: The method of aspect 6, further including: scrambling a set of bits to be transmitted via the second instance of the data message, where the set of bits correspond to a set of shaped constellation points and a set of unshaped constellation points, and where the set of shaped constellation points and the set of unshaped constellation points are uniformly distributed across a constellation set in accordance with scrambling the set of bits, and where the second power scaling is associated with a uniform distribution of constellation points in accordance with scrambling the set of bits.
Aspect 13: The method of any of aspects 6-12, further including: transmitting a third instance of the data message as a second retransmission of the data message, where transmitting the third instance of the data message includes applying a third power scaling to the second instance of the data message, where the third power scaling is different from the second power scaling.
Aspect 14: The method of any of aspects 1-13, further including: transmitting, to a second wireless device, an indication of the power scaling factor.
Aspect 15: The method of any of aspects 1-14, where selecting the power scaling factor includes: receiving, from a second device, an indication of the power scaling factor.
Aspect 16: A method for wireless communication at a wireless device, including: selecting, according to a coded modulation scheme associated with a data message and a probabilistic shaping scheme associated with information bits of the data message, a power scaling factor corresponding to the data message; and receiving the data message according to the coded modulation scheme, including decoding the information bits according to the probabilistic shaping scheme and accounting for a power scaling of the data message according to the power scaling factor.
Aspect 17: The method of aspect 16, where selecting the power scaling factor includes: selecting the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.
Aspect 18: The method of aspect 16, where selecting the power scaling factor includes: selecting an intermediate power scaling factor from a set of power scaling factors associated with a set of MCS parameters, where the set of power scaling factors is associated with the probabilistic shaping scheme, where the power scaling factor is a quotient of the intermediate power scaling factor and a second power scaling factor, where the second power scaling factor is associated with a uniform distribution of constellation points.
Aspect 19: The method of aspect 16, where selecting the power scaling factor includes: calculating the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.
Aspect 20: The method of any of aspects 16-19, further including: receiving a second instance of the data message as a retransmission of the data message, where receiving the second instance of the data message includes accounting for a second power scaling of the second instance of the data message.
Aspect 21: The method of aspect 20, where accounting for the second power scaling of the second instance of the data message includes: applying an inverse of the power scaling factor to a first portion of the second instance of the data message, where the first portion of the second instance of the data message corresponds to a set of shaped constellation points; and applying an inverse of a second power scaling factor to a second portion of the second instance of the data message, where the second portion of the second instance of the data message corresponds to set of unshaped constellation points.
Aspect 22: The method of aspect 20, where accounting for the second power scaling of the second instance of the data message includes: applying an inverse of a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.
Aspect 23: The method of aspect 22, further including: receiving, from a second wireless device, an indication of the second power scaling factor.
Aspect 24: The method of any of aspects 22-23, further including: unscrambling the set of shaped constellation points and the set of unshaped constellation points across one or both of a code block or a transport block associated with the second instance of the data message.
Aspect 25: The method of aspect 20, where receiving the second instance of the data message includes: receiving a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.
Aspect 26: The method of aspect 20, further including: unscrambling a set of bits received via the second instance of the data message, where the set of bits correspond to a set of shaped constellation points and a set of unshaped constellation points, and where the set of shaped constellation points and the set of unshaped constellation points are uniformly distributed across a constellation set in accordance with unscrambling the set of bits, and where the second power scaling is associated with a uniform distribution of constellation points in accordance with unscrambling the set of bits.
Aspect 27: The method of any of aspects 20-26, further including: receiving a third instance of the data message as a second retransmission of the data message, where receiving the third instance of the data message includes accounting for a third power scaling of the second instance of the data message, where the third power scaling is different from the second power scaling.
Aspect 28: The method of any of aspects 16-27, where selecting the power scaling factor includes: receiving, from a second wireless device, an indication of the power scaling factor.
Aspect 29: The method of any of aspects 16-28, further including: transmitting, to a second wireless device, an indication of the power scaling factor.
Aspect 30: An apparatus for wireless communication at a wireless device, including: a processing system configured to: select, according to a coded modulation scheme associated with a data message and a probabilistic shaping scheme associated with information bits of the data message, a power scaling factor corresponding to the data message; and an interface configured to: output the data message according to the coded modulation scheme, including encoding the information bits according to the probabilistic shaping scheme and applying a power scaling to the data message according to the power scaling factor.
Aspect 31: The apparatus of aspect 30, where, to select the power scaling factor, the processing system is further configured to: select the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.
Aspect 32: The apparatus of aspect 30, where, to select the power scaling factor, the processing system is further configured to: select an intermediate power scaling factor from a set of power scaling factors associated with a set of MCS parameters, where the set of power scaling factors is associated with the probabilistic shaping scheme, where the power scaling factor is a product of the intermediate power scaling factor and a second power scaling factor, and where the second power scaling factor is associated with a uniform distribution of constellation points.
Aspect 33: The apparatus of aspect 30, where, to select the power scaling factor, the processing system is further configured to: calculate the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.
Aspect 34: The apparatus of any of aspects 30-33, where the interface is further configured to: output a demodulation reference signal associated with the data message in accordance with the power scaling factor.
Aspect 35: The apparatus of any of aspects 30-34, where the interface is further configured to: output a second instance of the data message as a retransmission of the data message, where outputting the second instance of the data message includes applying a second power scaling to the second instance of the data message.
Aspect 36: The apparatus of aspect 35, where, to apply the second power scaling to the second instance of the data message, the processing system is further configured to: apply the power scaling factor to a first portion of the second instance of the data message, where the first portion of the second instance of the data message corresponds to a set of shaped constellation points; and apply a second power scaling factor to a second portion of the second instance of the data message, where the second portion of the second instance of the data message corresponds to set of unshaped constellation points.
Aspect 37: The apparatus of aspect 35, where, to apply the second power scaling to the second instance of the data message, the processing system is further configured to: apply a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.
Aspect 38: The apparatus of aspect 37, where the interface is further configured to: output, to a second wireless device, an indication of the second power scaling factor.
Aspect 39: The apparatus of any of aspects 37-38, where the processing system is further configured to: scramble the set of shaped constellation points and the set of unshaped constellation points across one or both of a code block or a transport block associated with the second instance of the data message.
Aspect 40: The apparatus of aspect 35, where, to output the second instance of the data message, the interface is configured to: output a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.
Aspect 41: The apparatus of aspect 35, where the processing system is further configured to: scramble a set of bits to be transmitted via the second instance of the data message, where the set of bits correspond to a set of shaped constellation points and a set of unshaped constellation points, and where the set of shaped constellation points and the set of unshaped constellation points are uniformly distributed across a constellation set in accordance with scrambling the set of bits, and where the second power scaling is associated with a uniform distribution of constellation points in accordance with scrambling the set of bits.
Aspect 42: The apparatus of any of aspects 35-41, where the interface is further configured to: output a third instance of the data message as a second retransmission of the data message, where outputting the third instance of the data message includes applying a third power scaling to the second instance of the data message, where the third power scaling is different from the second power scaling.
Aspect 43: The apparatus of any of aspects 30-42, where the interface is further configured to: output, to a second wireless device, an indication of the power scaling factor.
Aspect 44: The apparatus of any of aspects 30-43, where, to select the power scaling factor, the interface is further configured to: obtain, from a second wireless device, an indication of the power scaling factor.
Aspect 45: An apparatus for wireless communication at a wireless device, including: a processing system configured to: select, according to a coded modulation scheme associated with a data message and a probabilistic shaping scheme associated with information bits of the data message, a power scaling factor corresponding to the data message; and an interface configured to: obtain the data message according to the coded modulation scheme, including decoding the information bits according to the probabilistic shaping scheme and accounting for a power scaling of the data message according to the power scaling factor.
Aspect 46: The apparatus of aspect 45, where, to select the power scaling factor, the processing system is further configured to: select the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.
Aspect 47: The apparatus of aspect 45, where, to select the power scaling factor, the processing system is further configured to: select an intermediate power scaling factor from a set of power scaling factors associated with a set of MCS parameters, where the set of power scaling factors is associated with the probabilistic shaping scheme, where the power scaling factor is a product of the intermediate power scaling factor and a second power scaling factor, where the second power scaling factor is associated with a uniform distribution of constellation points.
Aspect 48: The apparatus of aspect 45, where, to select the power scaling factor, the processing system is further configured to: calculate the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.
Aspect 49: The apparatus of any of aspects 45-48, where the interface is further configured to: obtain a second instance of the data message as a retransmission of the data message, where obtaining the second instance of the data message includes accounting for a second power scaling of the second instance of the data message.
Aspect 50: The apparatus of aspect 49, where, to account for the second power scaling of the second instance of the data message, the processing system is further configured to: apply an inverse of the power scaling factor to a first portion of the second instance of the data message, where the first portion of the second instance of the data message corresponds to a set of shaped constellation points; and apply an inverse of a second power scaling factor to a second portion of the second instance of the data message, where the second portion of the second instance of the data message corresponds to set of unshaped constellation points.
Aspect 51: The apparatus of aspect 49, where, to account for the second power scaling of the second instance of the data message, the processing system is further configured to: apply an inverse of a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.
Aspect 52: The apparatus of aspect 51, where the interface is further configured to: obtain, from a second wireless device, an indication of the second power scaling factor.
Aspect 53: The apparatus of any of aspects 51-52, where the processing system is further configured to: unscramble the set of shaped constellation points and the set of unshaped constellation points across one or both of a code block or a transport block associated with the second instance of the data message.
Aspect 54: The apparatus of aspect 49, where, to obtain the second instance of the data message, the interface is further configured to: obtain a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.
Aspect 55: The apparatus of aspect 49, where the processing system is further configured to: unscramble a set of bits received via the second instance of the data message, where the set of bits correspond to a set of shaped constellation points and a set of unshaped constellation points, and where the set of shaped constellation points and the set of unshaped constellation points are uniformly distributed across a constellation set in accordance with unscrambling the set of bits, and where the second power scaling is associated with a uniform distribution of constellation points in accordance with unscrambling the set of bits.
Aspect 56: The apparatus of any of aspects 49-55, where the interface is further configured to: obtain a third instance of the data message as a second retransmission of the data message, where obtaining the third instance of the data message includes accounting for a third power scaling of the second instance of the data message, where the third power scaling is different from the second power scaling.
Aspect 57: The apparatus of any of aspects 45-56, where, to select the power scaling factor, the interface is further configured to: obtain, from a second wireless device, an indication of the power scaling factor.
Aspect 58: The apparatus of any of aspects 45-57, where the interface is further configured to: output, to a second wireless device, an indication of the power scaling factor.
Aspect 59: An apparatus for wireless communication at a wireless device, including: means for selecting, according to a coded modulation scheme associated with a data message and a probabilistic shaping scheme associated with information bits of the data message, a power scaling factor corresponding to the data message; and means for transmitting the data message according to the coded modulation scheme, including encoding the information bits according to the probabilistic shaping scheme and applying a power scaling to the data message according to the power scaling factor.
Aspect 60: The apparatus of aspect 59, where the means for selecting the power scaling factor include: means for selecting the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.
Aspect 61: The apparatus of aspect 59, where the means for selecting the power scaling factor include: means for selecting an intermediate power scaling factor from a set of power scaling factors associated with a set of MCS parameters, where the set of power scaling factors is associated with the probabilistic shaping scheme, where the power scaling factor is a quotient of the intermediate power scaling factor and a second power scaling factor, and where the second power scaling factor is associated with a uniform distribution of constellation points.
Aspect 62: The apparatus of aspect 59, where the means for selecting the power scaling factor include: means for calculating the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.
Aspect 63: The apparatus of any of aspects 59-62, further including: means for transmitting a demodulation reference signal associated with the data message in accordance with the power scaling factor.
Aspect 64: The apparatus of any of aspects 59-63, further including: means for transmitting a second instance of the data message as a retransmission of the data message, where transmitting the second instance of the data message includes applying a second power scaling to the second instance of the data message.
Aspect 65: The apparatus of aspect 64, where the means for applying the second power scaling to the second instance of the data message include: means for applying the power scaling factor to a first portion of the second instance of the data message, where the first portion of the second instance of the data message corresponds to a set of shaped constellation points; and means for applying a second power scaling factor to a second portion of the second instance of the data message, where the second portion of the second instance of the data message corresponds to set of unshaped constellation points.
Aspect 66: The apparatus of aspect 64, where the means for applying the second power scaling to the second instance of the data message include: means for applying a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.
Aspect 67: The apparatus of aspect 66, further including: means for transmitting, to a second wireless device, an indication of the second power scaling factor.
Aspect 68: The apparatus of any of aspects 66-67, further including: means for scrambling the set of shaped constellation points and the set of unshaped constellation points across one or both of a code block or a transport block associated with the second instance of the data message.
Aspect 69: The apparatus of aspect 64, where the means for transmitting the second instance of the data message include: means for transmitting a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.
Aspect 70: The apparatus of aspect 64, further including: means for scrambling a set of bits to be transmitted via the second instance of the data message, where the set of bits correspond to a set of shaped constellation points and a set of unshaped constellation points, and where the set of shaped constellation points and the set of unshaped constellation points are uniformly distributed across a constellation set in accordance with scrambling the set of bits, and where the second power scaling is associated with a uniform distribution of constellation points in accordance with scrambling the set of bits
Aspect 71: The apparatus of any of aspects 64-70, further including: means for transmitting a third instance of the data message as a second retransmission of the data message, where transmitting the third instance of the data message includes applying a third power scaling to the second instance of the data message, where the third power scaling is different from the second power scaling.
Aspect 72: The apparatus of any of aspects 59-71, further including: means for transmitting, to a second wireless device, an indication of the power scaling factor.
Aspect 73: The apparatus of any of aspects 59-72, where the means for selecting the power scaling factor include: means for receiving, from a second device, an indication of the power scaling factor.
Aspect 74: An apparatus for wireless communication at a wireless device, including: means for selecting, according to a coded modulation scheme associated with a data message and a probabilistic shaping scheme associated with information bits of the data message, a power scaling factor corresponding to the data message; and means for receiving the data message according to the coded modulation scheme, including decoding the information bits according to the probabilistic shaping scheme and accounting for a power scaling of the data message according to the power scaling factor.
Aspect 75: The apparatus of aspect 74, where the means for selecting the power scaling factor include: means for selecting the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.
Aspect 76: The apparatus of aspect 74, where the means for selecting the power scaling factor include: means for selecting an intermediate power scaling factor from a set of power scaling factors associated with a set of MCS parameters, where the set of power scaling factors is associated with the probabilistic shaping scheme, where the power scaling factor is a quotient of the intermediate power scaling factor and a second power scaling factor, where the second power scaling factor is associated with a uniform distribution of constellation points.
Aspect 77: The apparatus of aspect 74, where the means for selecting the power scaling factor include: means for calculating the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.
Aspect 78: The apparatus of any of aspects 74-77, further including: means for receiving a second instance of the data message as a retransmission of the data message, where receiving the second instance of the data message includes accounting for a second power scaling of the second instance of the data message.
Aspect 79: The apparatus of aspect 78, where the means for accounting for the second power scaling of the second instance of the data message include: means for applying an inverse of the power scaling factor to a first portion of the second instance of the data message, where the first portion of the second instance of the data message corresponds to a set of shaped constellation points; and means for applying an inverse of a second power scaling factor to a second portion of the second instance of the data message, where the second portion of the second instance of the data message corresponds to set of unshaped constellation points.
Aspect 80: The apparatus of aspect 78, where the means for accounting for the second power scaling of the second instance of the data message include: means for applying an inverse of a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.
Aspect 81: The apparatus of aspect 80, further including: means for receiving, from a second wireless device, an indication of the second power scaling factor.
Aspect 82: The apparatus of any of aspects 80-81, further including: means for unscrambling the set of shaped constellation points and the set of unshaped constellation points across one or both of a code block or a transport block associated with the second instance of the data message.
Aspect 83: The apparatus of aspect 78, where the means for receiving the second instance of the data message include: means for receiving a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.
Aspect 84: The apparatus of aspect 78, further including: means for unscrambling a set of bits received via the second instance of the data message, where the set of bits correspond to a set of shaped constellation points and a set of unshaped constellation points, and where the set of shaped constellation points and the set of unshaped constellation points are uniformly distributed across a constellation set in accordance with unscrambling the set of bits, and where the second power scaling is associated with a uniform distribution of constellation points in accordance with unscrambling the set of bits.
Aspect 85: The apparatus of any of aspects 78-84, further including: means for receiving a third instance of the data message as a second retransmission of the data message, where receiving the third instance of the data message includes accounting for a third power scaling of the second instance of the data message, where the third power scaling is different from the second power scaling.
Aspect 86: The apparatus of any of aspects 74-85, where the means for selecting the power scaling factor include: means for receiving, from a second wireless device, an indication of the power scaling factor.
Aspect 87: The apparatus of any of aspects 74-86, further including: means for transmitting, to a second wireless device, an indication of the power scaling factor.
Aspect 88: A non-transitory computer-readable medium storing code for wireless communication at a wireless device, the code including instructions executable by a processor to: select, according to a coded modulation scheme associated with a data message and a probabilistic shaping scheme associated with information bits of the data message, a power scaling factor corresponding to the data message; and transmit the data message according to the coded modulation scheme, including encoding the information bits according to the probabilistic shaping scheme and applying a power scaling to the data message according to the power scaling factor.
Aspect 89: The non-transitory computer-readable medium of aspect 88, where the instructions to select the power scaling factor are executable by the processor to: select the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.
Aspect 90: The non-transitory computer-readable medium of aspect 88, where the instructions to select the power scaling factor are executable by the processor to: select an intermediate power scaling factor from a set of power scaling factors associated with a set of MCS parameters, where the set of power scaling factors is associated with the probabilistic shaping scheme, where the power scaling factor is a quotient of the intermediate power scaling factor and a second power scaling factor, and where the second power scaling factor is associated with a uniform distribution of constellation points.
Aspect 91: The non-transitory computer-readable medium of aspect 88, where the instructions to select the power scaling factor are executable by the processor to: calculate the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.
Aspect 92: The non-transitory computer-readable medium of any of aspects 88-91, where the instructions are further executable by the processor to: transmit a demodulation reference signal associated with the data message in accordance with the power scaling factor.
Aspect 93: The non-transitory computer-readable medium of any of aspects 88-92, where the instructions are further executable by the processor to: transmit a second instance of the data message as a retransmission of the data message, where transmitting the second instance of the data message includes applying a second power scaling to the second instance of the data message.
Aspect 94: The non-transitory computer-readable medium of aspect 93, where the instructions to apply the second power scaling to the second instance of the data message are executable by the processor to: apply the power scaling factor to a first portion of the second instance of the data message, where the first portion of the second instance of the data message corresponds to a set of shaped constellation points; and apply a second power scaling factor to a second portion of the second instance of the data message, where the second portion of the second instance of the data message corresponds to set of unshaped constellation points.
Aspect 95: The non-transitory computer-readable medium of aspect 93, where the instructions to apply the second power scaling to the second instance of the data message are executable by the processor to: apply a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.
Aspect 96: The non-transitory computer-readable medium of aspect 95, where the instructions are further executable by the processor to: transmit, to a second wireless device, an indication of the second power scaling factor.
Aspect 97: The non-transitory computer-readable medium of any of aspects 95-96, where the instructions are further executable by the processor to: scramble the set of shaped constellation points and the set of unshaped constellation points across one or both of a code block or a transport block associated with the second instance of the data message.
Aspect 98: The non-transitory computer-readable medium of aspect 93, where the instructions to transmit the second instance of the data message are executable by the processor to: transmit a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.
Aspect 99: The non-transitory computer-readable medium of aspect 93, where the instructions are further executable by the processor to: scramble a set of bits to be transmitted via the second instance of the data message, where the set of bits correspond to a set of shaped constellation points and a set of unshaped constellation points, and where the set of shaped constellation points and the set of unshaped constellation points are uniformly distributed across a constellation set in accordance with scrambling the set of bits, and where the second power scaling is associated with a uniform distribution of constellation points in accordance with scrambling the set of bits.
Aspect 100: The non-transitory computer-readable medium of any of aspects 93-99, where the instructions are further executable by the processor to: transmit a third instance of the data message as a second retransmission of the data message, where transmitting the third instance of the data message includes applying a third power scaling to the second instance of the data message, where the third power scaling is different from the second power scaling.
Aspect 101: The non-transitory computer-readable medium of any of aspects 88-100, where the instructions are further executable by the processor to: transmit, to a second wireless device, an indication of the power scaling factor.
Aspect 102: The non-transitory computer-readable medium of any of aspects 88-101, where the instructions to select the power scaling factor are executable by the processor to: receive, from a second device, an indication of the power scaling factor.
Aspect 103: A non-transitory computer-readable medium storing code for wireless communication at a wireless device, the code including instructions executable by a processor to: select, according to a coded modulation scheme associated with a data message and a probabilistic shaping scheme associated with information bits of the data message, a power scaling factor corresponding to the data message; and receive the data message according to the coded modulation scheme, including decoding the information bits according to the probabilistic shaping scheme and accounting for a power scaling of the data message according to the power scaling factor.
Aspect 104: The non-transitory computer-readable medium of aspect 103, where the instructions to select the power scaling factor are executable by the processor to: select the power scaling factor from a set of power scaling factors associated with a set of MCS parameters, where the set of power scaling factors is associated with the probabilistic shaping scheme, and where the power scaling factor is associated with an index into the set of MCS parameters corresponding to the coded modulation scheme associated with the data message.
Aspect 105: The non-transitory computer-readable medium of aspect 103, where the instructions to select the power scaling factor are executable by the processor to: select an intermediate power scaling factor from a set of power scaling factors associated with a set of MCS parameters, where the set of power scaling factors is associated with the probabilistic shaping scheme, where the power scaling factor is a quotient of the intermediate power scaling factor and a second power scaling factor, where the second power scaling factor is associated with a uniform distribution of constellation points.
Aspect 106: The non-transitory computer-readable medium of aspect 103, where the instructions to select the power scaling factor are executable by the processor to: calculate the power scaling factor in accordance with one or more shaping parameters associated with the probabilistic shaping scheme, where the one or more shaping parameters include at least one of a probability distribution scaling factor, a shaping rate, or an entropy value associated with one or more modulation symbols used for the data message.
Aspect 107: The non-transitory computer-readable medium of any of aspects 103-106, where the instructions are further executable by the processor to: receive a second instance of the data message as a retransmission of the data message, where receiving the second instance of the data message includes accounting for a second power scaling of the second instance of the data message.
Aspect 108: The non-transitory computer-readable medium of aspect 107, where the instructions to account for the second power scaling of the second instance of the data message are executable by the processor to: apply an inverse of the power scaling factor to a first portion of the second instance of the data message, where the first portion of the second instance of the data message corresponds to a set of shaped constellation points; and apply an inverse of a second power scaling factor to a second portion of the second instance of the data message, where the second portion of the second instance of the data message corresponds to set of unshaped constellation points.
Aspect 109: The non-transitory computer-readable medium of aspect 107, where the instructions to account for the second power scaling of the second instance of the data message are executable by the processor to: apply an inverse of a second power scaling factor to the second instance of the data message, where the second instance of the data message corresponds to a set of shaped constellation points and a set of unshaped constellation points, and where the second power scaling factor is associated with a ratio between the set of shaped constellation points and the set of unshaped constellation points.
Aspect 110: The non-transitory computer-readable medium of aspect 109, where the instructions are further executable by the processor to: receive, from a second wireless device, an indication of the second power scaling factor.
Aspect 111: The non-transitory computer-readable medium of any of aspects 109-110, where the instructions are further executable by the processor to: unscramble the set of shaped constellation points and the set of unshaped constellation points across one or both of a code block or a transport block associated with the second instance of the data message.
Aspect 112: The non-transitory computer-readable medium of aspect 107, where the instructions to receive the second instance of the data message are executable by the processor to: receive a set of unshaped constellation points, where the second instance of the data message excludes shaped constellation points in accordance with the data message including the information bits associated with the probabilistic shaping scheme, and where the second power scaling is associated with a uniform distribution of constellation points in accordance with excluding the shaped constellation points.
Aspect 113: The non-transitory computer-readable medium of aspect 107, where the instructions are further executable by the processor to: unscramble a set of bits received via the second instance of the data message, where the set of bits correspond to a set of shaped constellation points and a set of unshaped constellation points, and where the set of shaped constellation points and the set of unshaped constellation points are uniformly distributed across a constellation set in accordance with unscrambling the set of bits, and where the second power scaling is associated with a uniform distribution of constellation points in accordance with unscrambling the set of bits.
Aspect 114: The non-transitory computer-readable medium of any of aspects 107-113, where the instructions are further executable by the processor to: receive a third instance of the data message as a second retransmission of the data message, where receiving the third instance of the data message includes accounting for a third power scaling of the second instance of the data message, where the third power scaling is different from the second power scaling.
Aspect 115: The non-transitory computer-readable medium of any of aspects 103-114, where the instructions to select the power scaling factor are executable by the processor to: receive, from a second wireless device, an indication of the power scaling factor.
Aspect 116: The non-transitory computer-readable medium of any of aspects 103-115, where the instructions are further executable by the processor to: transmit, to a second wireless device, an indication of the power scaling factor.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data stored in memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented using hardware or software depends upon the particular application and design constraints imposed on the overall system.

The hardware and data processing apparatus used to implement the various illustrative logics, logical blocks, modules and circuits described in connection with the aspects disclosed herein may be implemented or performed using a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented using hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted using one or more instructions or code of a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one location to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc. Disks may reproduce data magnetically and discs may reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communication at a wireless device, comprising:
a processing system configured to:
select, according to a coded modulation scheme associated with a data message and a probabilistic shaping scheme associated with information bits of the data message, a power scaling factor corresponding to the data message; and
an interface configured to:
output the data message according to the coded modulation scheme, including encoding the information bits according to the probabilistic shaping scheme and applying a power scaling to the data message according to the power scaling factor.

2. The apparatus of claim 1, wherein, to select the power scaling factor, the processing system is further configured to:
select the power scaling factor from a set of power scaling factors associated with a set of modulation and coding scheme (MCS) parameters, wherein the set of power scaling factors is associated with the probabilistic shaping scheme, and wherein the power scaling factor is associated with an index into the set of MCS parameters corresponding to the coded modulation scheme associated with the data message.

3. The apparatus of claim 1, wherein, to select the power scaling factor, the processing system is further configured to:
select an intermediate power scaling factor from a set of power scaling factors associated with a set of modulation and coding scheme (MCS) parameters, wherein the set of power scaling factors is associated with the probabilistic shaping scheme, wherein the power scaling factor is a product of the intermediate power scaling factor and a second power scaling factor, and wherein the second power scaling factor is associated with a uniform distribution of constellation points.

4. The apparatus of claim 1, wherein, to select the power scaling factor, the processing system is further configured to:
calculate the power scaling factor in accordance with one or more shaping parameters associated with the probabilistic shaping scheme, wherein the one or more shaping parameters include at least one of a probability distribution scaling factor, a shaping rate, or an entropy value associated with one or more modulation symbols used for the data message.

5. The apparatus of claim 1, wherein the interface is further configured to:
output a demodulation reference signal associated with the data message in accordance with the power scaling factor.

6. The apparatus of claim 1, wherein the interface is further configured to:
output a second instance of the data message as a retransmission of the data message, wherein outputting the second instance of the data message includes applying a second power scaling to the second instance of the data message.

7. The apparatus of claim 6, wherein, to apply the second power scaling to the second instance of the data message, the processing system is further configured to:
apply the power scaling factor to a first portion of the second instance of the data message, wherein the first portion of the second instance of the data message corresponds to a set of shaped constellation points; and
apply a second power scaling factor to a second portion of the second instance of the data message, wherein the second portion of the second instance of the data message corresponds to set of unshaped constellation points.

8. The apparatus of claim 6, wherein, to apply the second power scaling to the second instance of the data message, the processing system is further configured to:
apply a second power scaling factor to the second instance of the data message, wherein the second instance of the data message corresponds to a set of shaped constellation points and a set of unshaped constellation points, and wherein the second power scaling factor is associated with a ratio between the set of shaped constellation points and the set of unshaped constellation points.

9. The apparatus of claim 8, wherein the interface is further configured to:
output, to a second wireless device, an indication of the second power scaling factor.

10. The apparatus of claim 8, wherein the processing system is further configured to:
scramble the set of shaped constellation points and the set of unshaped constellation points across one or both of a code block or a transport block associated with the second instance of the data message.

11. The apparatus of claim 6, wherein, to output the second instance of the data message, the interface is configured to:
output a set of unshaped constellation points, wherein the second instance of the data message excludes shaped constellation points in accordance with the data message including the information bits associated with the probabilistic shaping scheme, and wherein the second power scaling is associated with a uniform distribution of constellation points in accordance with excluding the shaped constellation points.

12. The apparatus of claim 6, wherein the processing system is further configured to:
scramble a set of bits to be transmitted via the second instance of the data message, wherein the set of bits correspond to a set of shaped constellation points and a set of unshaped constellation points, and wherein the set of shaped constellation points and the set of unshaped constellation points are uniformly distributed across a constellation set in accordance with scrambling the set of bits, and wherein the second power scaling is associated with a uniform distribution of constellation points in accordance with scrambling the set of bits.

13. The apparatus of claim 6, wherein the interface is further configured to:
output a third instance of the data message as a second retransmission of the data message, wherein outputting the third instance of the data message includes applying a third power scaling to the second instance of the data message, wherein the third power scaling is different from the second power scaling.

14. The apparatus of claim 1, wherein the interface is further configured to:
output, to a second wireless device, an indication of the power scaling factor.

15. The apparatus of claim 1, wherein, to select the power scaling factor, the interface is further configured to:
obtain, from a second wireless device, an indication of the power scaling factor.

16. An apparatus for wireless communication at a wireless device, comprising:
a processing system configured to:
select, according to a coded modulation scheme associated with a data message and a probabilistic shaping scheme associated with information bits of the data message, a power scaling factor corresponding to the data message; and
an interface configured to:
obtain the data message according to the coded modulation scheme, including decoding the information bits according to the probabilistic shaping scheme and accounting for a power scaling of the data message according to the power scaling factor.

17. The apparatus of claim 16, wherein, to select the power scaling factor, the processing system is further configured to:
select the power scaling factor from a set of power scaling factors associated with a set of modulation and coding scheme (MCS) parameters, wherein the set of power scaling factors is associated with the probabilistic shaping scheme, and wherein the power scaling factor is associated with an index into the set of MCS parameters corresponding to the coded modulation scheme associated with the data message.

18. The apparatus of claim 16, wherein, to select the power scaling factor, the processing system is further configured to:
select an intermediate power scaling factor from a set of power scaling factors associated with a set of modulation and coding scheme (MCS) parameters, wherein the set of power scaling factors is associated with the probabilistic shaping scheme, wherein the power scaling factor is a product of the intermediate power scaling factor and a second power scaling factor, wherein the second power scaling factor is associated with a uniform distribution of constellation points.

19. The apparatus of claim 16, wherein, to select the power scaling factor, the processing system is further configured to:
calculate the power scaling factor in accordance with one or more shaping parameters associated with the probabilistic shaping scheme, wherein the one or more shaping parameters include at least one of a probability distribution scaling factor, a shaping rate, or an entropy value associated with one or more modulation symbols used for the data message.

20. The apparatus of claim 16, wherein the interface is further configured to:
obtain a second instance of the data message as a retransmission of the data message, wherein obtaining the second instance of the data message includes accounting for a second power scaling of the second instance of the data message.

21. A method for wireless communication at a wireless device, comprising:
selecting, according to a coded modulation scheme associated with a data message and a probabilistic shaping scheme associated with information bits of the data message, a power scaling factor corresponding to the data message; and
transmitting the data message according to the coded modulation scheme, including encoding the information bits according to the probabilistic shaping scheme and applying a power scaling to the data message according to the power scaling factor.

22. The method of claim 21, wherein selecting the power scaling factor comprises:
selecting the power scaling factor from a set of power scaling factors associated with a set of modulation and coding scheme (MCS) parameters, wherein the set of power scaling factors is associated with the probabilistic shaping scheme, and wherein the power scaling factor is associated with an index into the set of MCS parameters corresponding to the coded modulation scheme associated with the data message.

23. The method of claim 21, wherein selecting the power scaling factor comprises:
selecting an intermediate power scaling factor from a set of power scaling factors associated with a set of modulation and coding scheme (MCS) parameters, wherein the set of power scaling factors is associated with the probabilistic shaping scheme, wherein the power scaling factor is a product of the intermediate power scaling factor and a second power scaling factor, and wherein the second power scaling factor is associated with a uniform distribution of constellation points.

24. The method of claim 21, wherein selecting the power scaling factor comprises:
calculating the power scaling factor in accordance with one or more shaping parameters associated with the probabilistic shaping scheme, wherein the one or more shaping parameters include at least one of a probability distribution scaling factor, a shaping rate, or an entropy value associated with one or more modulation symbols used for the data message.

25. The method of claim 21, further comprising:
transmitting a second instance of the data message as a retransmission of the data message, wherein transmitting the second instance of the data message includes applying a second power scaling to the second instance of the data message.

26. The method of claim 25, wherein applying the second power scaling to the second instance of the data message comprises:
applying the power scaling factor to a first portion of the second instance of the data message, wherein the first portion of the second instance of the data message corresponds to a set of shaped constellation points; and
applying a second power scaling factor to a second portion of the second instance of the data message, wherein the second portion of the second instance of the data message corresponds to set of unshaped constellation points.

27. A method for wireless communication at a wireless device, comprising:
selecting, according to a coded modulation scheme associated with a data message and a probabilistic shaping scheme associated with information bits of the data message, a power scaling factor corresponding to the data message; and
receiving the data message according to the coded modulation scheme, including decoding the information bits according to the probabilistic shaping scheme and accounting for a power scaling of the data message according to the power scaling factor.

28. The method of claim 27, wherein selecting the power scaling factor comprises:
selecting the power scaling factor from a set of power scaling factors associated with a set of modulation and coding scheme (MCS) parameters, wherein the set of power scaling factors is associated with the probabilistic shaping scheme, and wherein the power scaling factor is associated with an index into the set of MCS parameters corresponding to the coded modulation scheme associated with the data message.

29. The method of claim 27, wherein selecting the power scaling factor comprises:
selecting an intermediate power scaling factor from a set of power scaling factors associated with a set of modulation and coding scheme (MCS) parameters, wherein the set of power scaling factors is associated with the probabilistic shaping scheme, wherein the power scaling factor is a product of the intermediate power scaling factor and a second power scaling factor, wherein the second power scaling factor is associated with a uniform distribution of constellation points.

30. The method of claim 27, wherein selecting the power scaling factor comprises:
calculating the power scaling factor in accordance with one or more shaping parameters associated with the probabilistic shaping scheme, wherein the one or more shaping parameters include at least one of a probability distribution scaling factor, a shaping rate, or an entropy value associated with one or more modulation symbols used for the data message.
